(19) United States
(12) Patent Application Publication
(10) Pub. No.: US 2025/0130140 A1
(43) Pub. Date: Apr. 24, 2025

(54) METHODS AND DEVICES FOR COLLECTING AND ANALYZING AEROSOL PARTICLES

(71) Applicant: THE USA, AS REPRESENTED BY THE SECRETARY, DEPT. OF HEALTH AND HUMAN SERVICES, Bethesda, MD (US)

(72) Inventors: Pramod S. Kulkarni, Mason, OH (US); Orthodoxia Zervaki, Cincinnati, MD (US)

(21) Appl. No.: 18/832,139

(22) PCT Filed: Jan. 27, 2023
(86) PCT No.: PCT/US2023/011708

§ 371 Date: Jul. 23, 2024

Related U.S. Application Data
(60) Provisional application No. 63/304,260, filed on Jan. 28, 2022.

(51) Int. Cl. G01N 1/22; G01N 1/40; G01N 1/44; G01N 15/00; G01N 15/06

(52) U.S. Cl. CPC G01N 1/2202; G01N 1/4022; G01N 1/44; G01N 15/0612; G01N 2001/2223; G01N 2001/4033; G01N 2015/0038; G01N 2015/0681

(57) ABSTRACT

A device (200) for collecting and analyzing aerosol particles includes a fluid storage tank (206) for generating a condensing fluid (256) having a first temperature; and an aerosol collection port (202) having a vapor inlet (212) for receiving the condensing fluid, and an aerosol inlet (222) for receiving an aerosol stream having a second temperature that is lower than the first temperature. The condensing fluid (256) is mixed with the aerosol stream in the aerosol collection port (202) producing a mixed stream. The device also includes a growth tube (204) configured to receive the mixed stream and condense aerosol particles to form a gaseous stream containing grown droplets which contain aerosol particles; and a converging nozzle (248) in fluid communication with the growth tube (204). The device allows for semi-continuous measurement of aerosol samples, and the measurement cycle can include: i) collection of particles onto a substrate (238), ii) analysis using spectroscopic techniques, and iii) removal of samples and preparing for next measurement.

### CROSS REFERENCE TO RELATED APPLICATION

This application claims priority of U.S. Provisional Application No. 63/304,260, filed Jan. 28, 2022, the content of which is incorporated herein in its entirety by reference.

### STATEMENT OF GOVERNMENT SUPPORT

This invention was made in part with government support from the US Centers for Disease Control and Prevention. The United States government has certain rights in this invention.

### BACKGROUND OF THE INVENTION

### 1. Field of the Invention

This invention relates generally to methods and devices that allow concentration and collection of aerosol particles from an air sample onto a substrate followed by chemical analysis of the collected sample using various spectroscopic methods, thereby allowing automated semi-continuous analysis.

### 2. Brief Description of the Art

Exposure to hazardous airborne particles can pose a significant health risk to those routinely exposed in an ambient environment and in industrial workplaces. Measurement of chemical composition and concentration of aerosols is important for the prevention of exposure and protection of human health.

Currently widely used methods for environmental and workplace aerosol chemical measurement involve particle collection on filters over several hours, followed by subsequent laboratory analysis. These methods can provide time-averaged air concentrations; however, they cannot capture transient exposures. They are time- and resource-intensive and provide analytical results several days after the exposure has occurred. Low-cost, portable, real-time aerosol chemical analysis instrumentation is therefore needed for effectively assessing and preventing human exposure to hazardous airborne particles.

### SUMMARY OF THE INVENTION

In an aspect, the present invention is directed to a device for collecting and analyzing aerosol particles. The device includes a fluid storage tank for generating a condensing fluid comprising a vapor, the condensing fluid having a first temperature; an aerosol collection port having a vapor inlet for receiving the condensing fluid generated from the fluid storage tank, and an aerosol inlet for receiving an aerosol stream containing aerosol particles, the aerosol stream having a second temperature that is lower than the first temperature, wherein the condensing fluid is mixed with the aerosol stream in the aerosol collection port producing a mixed stream; a growth tube configured to receive the mixed stream from the aerosol collection port and condense the aerosol particles to form a gaseous stream containing grown droplets that contain aerosol particles; and a converging nozzle in fluid communication with the growth tube, the converging nozzle focusing the condensed fluid into an aerosol beam containing the grown droplets.

A method for analyzing aerosol particles using the above described device includes generating the condensing fluid containing the vapor; mixing the condensing fluid with the aerosol stream in the aerosol collection port to produce a mixed stream; introducing the mixed stream to the growth tube; condensing the aerosol particles to form the gaseous stream containing grown droplets that contain aerosol particles in the growth tube; and focusing the gaseous stream containing the grown droplets into an aerosol beam.

In another aspect, a device for collecting and analyzing aerosol particles includes a converging nozzle for discharging an aerosol stream containing aerosol particles; a collection substrate located downstream of the converging nozzle for collecting the aerosol particles from the aerosol stream; a controller coupled to the collection substrate for controlling a rotation of the collection substrate; and a means for ablating the aerosol particles on the collection substrate.

A method for analyzing aerosol particles includes collecting aerosol particles on a collection substrate at an original orientation; rotating the collection substrate to a new ablating orientation; and ablating the aerosol particles on the collection substrate in the new ablating orientation; and rotating the collection substrate back to the original orientation for subsequent collection of next sample of aerosol particles. Optionally, ablating the aerosol particles generates an atomic emission; and the method further comprises analyzing the atomic emission to characterize the aerosol particles on the collection substrate.

In still another aspect, a method for analyzing aerosol particles includes analyzing first aerosol particles on a first surface of a collection substrate; ablating second aerosol particles on a second surface of the collection substrate to generating an atomic emission; and analyzing the atomic emission to characterize the second aerosol particles on the collection substrate, wherein optionally the first aerosol particles and the second aerosol particles are collected from the same or different aerosol streams.

### BRIEF DESCRIPTION OF THE DRAWINGS

A description of the figures, which are meant to be exemplary and not limiting, is provided in which:

FIG. 1A is a three-dimensional view of an embodiment of a device for collecting and analyzing aerosol particles, where the device includes a spot-sample mixing-flow condensation aerosol concentrator, namely, spot-sample MCAC that collects a spot sample;

FIG. 1B is a cross-sectional view of the device of FIG. 1A along line A-A;

FIG. 2 is a section view of another embodiment of a device for collecting aerosol particles (also referred to as a liquid-sample MCAC, which collects a liquid sample);

FIG. 3A is a three-dimensional view of another embodiment of a device for analyzing aerosol particles;

FIG. 3B is a cross-sectional view of the device of FIG. 3A along line A-A;

FIG. 3C is a schematic diagram showing the procedure of measurement using the device of FIG. 3A;

FIG. 4 shows an example of a device for collecting and analyzing aerosol particles;

FIGS. 5A, 5B, 5C, and 5D show theoretical saturation ratio calculated compared to the experimental activation efficiency (>1,400 nm) measured in a spot-sample MCAC, for 25 nm particles of NaCl, at saturator temperatures equal to 70, 75, 80 and 85° C. respectively, where the dashed line represents a fitting curve for the experimentally measured growth efficiency, and the error bars indicate the standard deviation that was calculated from the three replicates;

FIG. 6A shows activation efficiency of a spot-sample MCAC based on >300 nm, >700 nm, and >1,400 nm when Tₛₐₜ=70° C.;

FIG. 6B shows activation efficiency based on >1400 nm droplet size fraction measured in a spot-sample MCAC when Tₛₐₜ is set at 70° C., 75° C., 80° C. and 85° C. respectively, where the aerosol flow had a temperature of 22° C. and 100% humidity, and the error bars indicate the standard derivation that was calculated from the three replicates;

FIGS. 7A, 7B, 7C, and 7D show activation efficiency of a spot-sample MCAC based on >300 nm, >700 nm, and >1,400 nm droplet size fractions measured as a function of the saturator temperature, for 25 nm NaCl particles and aerosol inlet humidities of (a) 100%, (b) 25%, (c) 15% and (d) 11% respectively, where the aerosol flow had a temperature of 22° C., and the error bars indicate the standard deviation extracted from the three replicates;

FIG. 8 shows activation efficiency of a spot-sample MCAC measured using different fractions of grown droplet diameters, >300 nm, >700, and >1,400 nm, as a function of the operation time (minutes, min), for 25 nm NaCl particles, where the aerosol flow had a temperature of 22° C. and 100% humidity, and the measurement was initiated when the saturator temperature reached 80° C., and a flowrate of 4 L min⁻¹ was employed for the aerosol stream, and a flowrate of 0.4 L min⁻¹ was implemented for the water vapor stream;

FIGS. 9A, 9B, and 9C are scanning electron microscope (SEM) images of deposited aerosol sample area of 20 nm, 150 nm and 1,900 nm diameter polystyrene spheres, where the droplet collection was attained through a spot-sample MCAC, while Tₛₐₜ=75° C., Qₕ=0.6 L min⁻¹, Q_{c}-4 L min⁻¹, Tₐₑᵣₒₛₒₗ=23° C., RHₐₑᵣₒₛₒₗ=59-65% and T_{substrate}=90-100° C.;

FIGS. 10A, 10B, and 10C are axial distributions of deposited aerosol sample area of 20 nm, 150 nm and 1,900 nm diameter polystyrene spheres of FIGS. 9A, 9B, and 9C respectively;

FIG. 11 shows the activation efficiency of a spot-sample MCAC based on grown droplet diameter >300 nm, >700 nm, and >1400 nm, as a function of the aerosol number concentration of monodisperse test aerosol (with 25 nm diameter), where the aerosol flow was 22° C. and 100% humidity, and a flowrate of 4 L min⁻¹ was used for the aerosol stream and a flowrate of 0.6 L min⁻¹ was implemented for the water vapor stream, and the saturator temperature was set at 75° C.;

FIG. 12 shows the activation efficiency of a liquid-sample MCAC as a function of the saturator temperature, where sodium chloride aerosols with an aerodynamic diameter of 100 nm (Tₐₑᵣₒₛₒₗ=23.6-24.9° C., RHₐₑᵣₒₛₒₗ=45.8-51.5%), and the growth tube temperature was fixed at 0° C., and the error bars represent the standard derivation calculated from three replicate measurements;

FIG. 13A shows the activation efficiency of a liquid-sample MCAC as a function of the aerosol aerodynamic diameter (nm);

FIG. 13B shows the activation efficiency of a liquid-sample MCAC as a function of the operation time (min), where sodium chloride aerosols were used (Tₐₑᵣₒₛₒₗ=22.5-25.3° C., RHₐₑᵣₒₛₒₗ=46.6-56%);

FIG. 14 shows activation efficiency of growth droplets, in a liquid-sample MCAC, as a function of the growth tube temperature (C), where sodium chloride aerosols were used with an aerodynamic diameter of 100 nm (Tₐₑᵣₒₛₒₗ=23.7-24.9° C., RHₐₑᵣₒₛₒₗ=46.5-52.2%);

FIG. 15 shows activation efficiency of grown droplets, in a liquid-sample MCAC, as a function of the relative humidity (%) of the inlet aerosol-laden stream, where sodium chloride aerosols were used with an aerodynamic diameter of 100 nm, and the inlet aerosol laden stream had a temperature of 25° C., and the saturator temperature was set at 85° C.;

FIG. 16 shows number concentration-dependent collection efficiency of respirable silica particles, in a liquid-sample MCAC, where the input particle flow rate used as 10 L min⁻¹, the temperature of the saturator and growth tube wall was maintained at 85° C. and 0° C. respectively;

FIG. 17 compares the particulate mass collected via a liquid-sample MCAC and a reference filter, where the dashed line represents the linear fit curve corresponding to the experimental data, and the error bars represent the standard derivation of the three weight replicate measurements of the filters;

FIG. 18A shows the calibration curve for crystalline silica that shows the Raman peak signal intensity as a function of the mass measurement obtained from the quartz crystal microbalance (QCM) MOUDI™ impactor, where two types of nozzles, a single-stage nozzle (SSN), and a multi-stage nozzle (MSN) were used for collection;

FIG. 18B shows the calibration curves for rutile titanium dioxide/titania that shows the Raman peak signal intensity as a function of the mass measurement obtained from the QCM MOUDI™ impactor, where only the SSN was used for collection;

FIG. 19A shows measurement of crystalline silica/quartz mass in fracking dust samples collected on the electrode for 2, 3, and 4 hours;

FIG. 19B shows measurement of titania mass in a 5:1:1 mixture of titania, Arizona road dust and diesel particulate matter, where the estimated titania mass and the mass mixture mass measured from the QCM MOUDI was used to determine the titania percentage as shown in the pie-chart;

FIG. 20 shows short-term measurement of crystalline silica using the Raman method in the aerosol collection and analysis device (FIG. 4), in a transient aerosol simulating work activity, where the total aerosol concentration was maintained high to allow shorter collection times;

FIG. 21A shows the detection of diesel particulate matter (DPM) using the disclosed Raman instrument;

FIG. 21B shows the detection of graphene using the disclosed Raman instrument;

FIG. 21C shows the detection of single-walled carbon nanotubes (SWCNTs) using the disclosed Raman instrument; and

FIG. 21D shows the detection of chromium VI using the disclosed Raman instrument.

The above described and other features are exemplified by the following detailed description and Examples.

### DETAILED DESCRIPTION OF THE INVENTION

Disclosed herein is a sampling and analytical device that may be used to collect and analyze aerosol particles from ambient (outdoor) or indoor air atmospheres in real time. The sampling and analytical device comprises an aerosol collection port that is in fluid communication with a growth tube and a fluid storage tank. The aerosol collection port is effective to take in aerosols at a much higher fluid rate than a condensing fluid provided to the collection port from the fluid storage tank. This permits collection of a large concentration of aerosol particles when the condensing fluid is removed from the aerosol particle-condensing fluid combination.

The growth tube lies downstream of the aerosol collection port and facilitates nucleation and growth of the aerosol particles after they blend with the condensation fluid. In an embodiment, the growth tube lies directly downstream of the aerosol collection port. The fluid storage tank lies downstream of the aerosol collection port and the growth tube. In an embodiment, the fluid storage tank is in direct contact with the growth tube. The fluid storage tank is in a recycle loop with the aerosol collection port via a tube that charges the condensing fluid to the aerosol collection port. The fluid storage tank therefore lies both upstream and downstream of the aerosol inlet port.

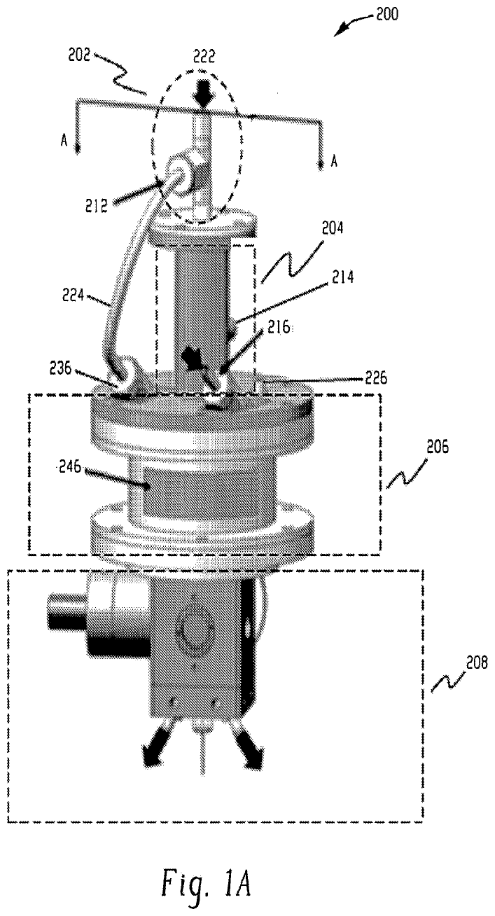

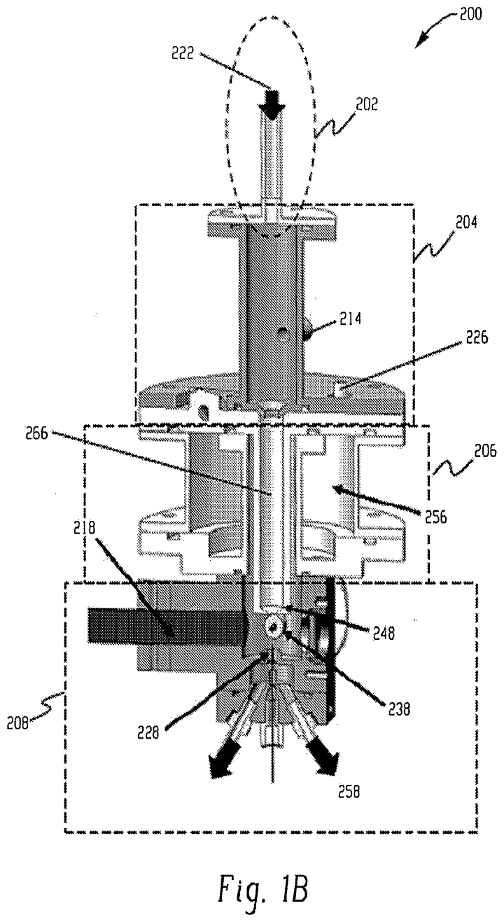

Referring to FIG. 1A and FIG. 1B, an analytical device (200) comprises an aerosol collection port (202), which has a vapor inlet (212) for receiving a condensing fluid generated from the fluid storage tank (206), and an aerosol inlet (222) for receiving an aerosol stream containing aerosol particles. In the aerosol collection port (202), the condensing fluid and the aerosol stream can instantly and adiabatically mix, forming a mixed stream.

In an embodiment, the condensing fluid is in vapor form prior to entry to the aerosol collection port 202 and has a higher temperature than the aerosol stream. In an embodiment, the condensing fluid is at a first temperature and the aerosol stream is at a second temperature that is lower than the first temperature prior to contacting each other. A temperature of the condensing fluid can be 75 to 95° C. or 75 to 85° C., and the aerosol stream can be at a room temperature for example 15 to 30° C. The condensing fluid and the aerosol stream contact each other in the aerosol collection port 202. Upon instant and adiabatic mixing, the vapor molecules can attach to the aerosol particles. In an embodiment, the vapor condenses on the aerosol particles.

A variety of fluids may be used as the condensing fluid. Examples of fluids are aqueous solvents, organic solvents, or a combination thereof. Organic solvents that are not toxic to living beings are preferred.

Examples of organic solvents are aprotic polar solvents, polar protic solvents, non-polar solvents, or a combination thereof. Examples of liquid aprotic polar solvents are propylene carbonate, ethylene carbonate, butyrolactone, acetonitrile, benzonitrile, nitromethane, nitrobenzene, sulfolane, dimethylformamide, N-methylpyrrolidone, or the like, or a combination thereof. Examples of polar protic solvents are water, alcohols such as methanol, ethanol, propanol, isopropanol and butanol; acetonitrile, nitromethane, or the like, or a combination thereof. Examples of non-polar solvents are benzene, toluene, methylene chloride, carbon tetrachloride, hexane, diethyl ether, tetrahydrofuran, or the like, or a combination thereof. Co-solvents comprising at least one aprotic polar solvent and at least one non-polar solvent may also be utilized to modify the swelling power of the solvent for the aerosol particles. In an exemplary embodiment, the condensing fluid is water in vapor form. In another exemplary embodiment, the condensing fluid is water and an alcohol in vapor form.

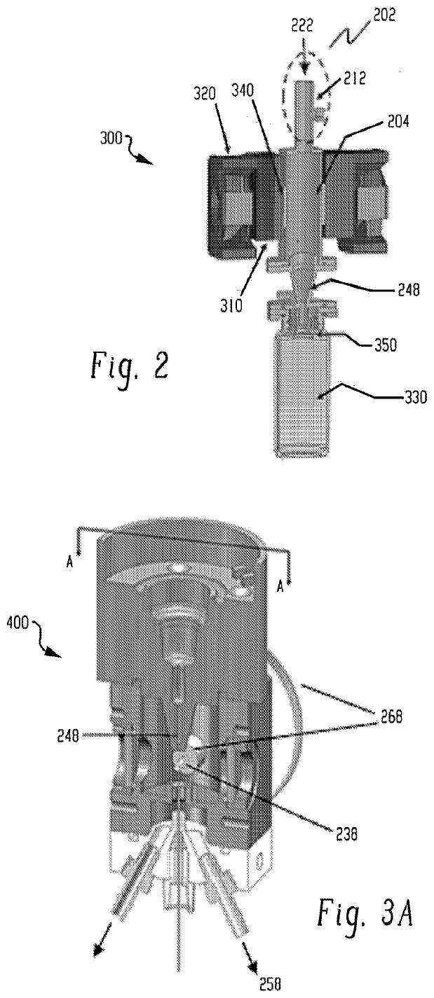

The aerosol stream can have a relative humidity of 9 to 100% or 25 to 100%. For example, for the spot-sample MCAC as shown in FIG. 1A, the inlet aerosol stream can have a relative humidity of 25 to 100%. For the liquid-sample MCAC as shown in FIG. 2, the inlet aerosol stream can have a relative humidity of 9 to 100%.

The device (200) allows for the collection of aerosol particles at a relatively high aerosol flowrate. In an embodiment, the aerosol stream is introduced to the aerosol collection port (202) at a flowrate of 1 to 20 liters per minute, 1 to 10 liters per minute, or 2 to 8 liters per minute. Compared to the aerosol stream, the condensing fluid is introduced to the aerosol collection port (202) at a slower flowrate, such as at a flowrate of 0.08 to 1.5 liters per minute or 0.1 to 1 liter per minute. The condensing fluid-to-aerosol stream flowrate ratio can be 0.01 to 0.5, preferably 0.05 to 0.5, more preferably 0.07 to 0.3.

To accommodate the high flowrate, the aerosol collection port (202) can be a “tee” port where the aerosol stream can enter from the top, and the condensing fluid can enter from the side. In an embodiment (not shown), the aerosol stream can contact the incoming condensing fluid in the aerosol collection port (202) at an angle of 30 to 150 degrees, preferably 60 to 120 degrees. The configuration can minimize particle losses in the interior of the aerosol collection port (202).

The aerosol collection port (202) can be in the form of a tube with a volume of 0.1 to 5 cubic centimeters. The residence time of the aerosol stream and the condensing fluid in the aerosol collection port (202) can range from 1 to 5 milliseconds.

The device (200) also has a growth tube (204) that is in fluid communication with the aerosol collection port (202) and lies downstream of the aerosol collection port (202). In the growth tube (204), the temperature of the mixed stream generated from the aerosol collection port (202) drops, and the vapor molecules condense onto the aerosol particles, thus allowing the aerosol particles to act as seeds and promote growth into droplets.

The growth tube (204) can have a larger volume than the aerosol collection port (202). Optionally the mixed stream enters the growth tube (204) through an orifice, which has a smaller diameter than the growth tube (204). Thus, upon entering the growth tube (204), the mixed stream expands in volume, and the temperature of the mixed stream may be lowered because of this expansion. Upon undergoing a decrease in temperature in the growth tube 204, the vapor of the condensing fluid may condense on the aerosol particles, and the aerosol particles can act as nucleation sites forming droplets that contain aerosol particles. In an embodiment, the droplets can be referred to as particle-encapsulated droplets. The droplets can grow in the growth tube, and the grown droplets are then collected, and the aerosol particles in the droplets are analyzed as detailed below. Optionally, the interior wall of the growth tube can be covered with a liner, for example a porous filter paper liner, on which the excess vapor in the condensing fluid condenses. A pump, located outside the growth tube, can be used to remove the condensed fluid from the liner to prevent excess fluid accumulation on the inside walls of the growth tube.

The drop of the temperature can also occur through the contact of the mixed stream with the walls of the growth tube (204). In an embodiment, there is no cooling device coupled to the growth chamber (204). Without “active” cooling, the temperature at the walls of the growth tube (204) can be 15 to 25° C. Alternatively, the growth tube (204) is cooled by one or more cooling devices such that the temperature at the walls of the growth tube (204) is lowered to less than 15° C. preferably 0° C. to 13° C., 0° C. to 10° C., or about 0° C. The “active” cooling of the growth tube can enhance the particle growth and is beneficial for achieving higher aerosol stream flowrates.

The interior walls of the growth tube (204) can be covered with a filter membrane. Excess of the vapor that condenses on the interior walls of the growth tube (204) can be collected on the filter, and then removed by a pump through an outlet (214) on a sidewall of the growth tube (204).

The inside diameter and the length of the growth tube (204) can be 10 to 25 millimeters and 40 to 50 millimeters respectively. Other dimensions are also possible.

Aerosol particles with an initial aerodynamic diameter of approximately 3 nm to 1 micrometer diameter or more can be grown to sizes of greater than 1 micrometer, greater than 1.5 micrometers, or greater than 2 micrometers in the growth tube (204). The wider the temperature “gap” between the condensing fluid and the aerosol stream, the larger the enlarged or grown droplets would be.

The condensing fluid, which facilitates the growth of the aerosol particles, is generated in the fluid storage tank (206). The storage tank (206) contains the condensing fluid (256). The condensing fluid (e.g., water), may be added to the tank (206) via a liquid inlet (226). The fluid storage tank (206) has a heater (246) that is operative to heat the condensing fluid in the tank (206) to generate a vapor. Optionally the tank has a temperature sensor (not shown). Both the temperature sensor and the heater (246) can be connected to a temperature controller if desired. Preferably the vapor is generated at a temperature of 75 to 95° C. or 75 to 85° C.

The interior of the fluid storage tank (206) can be equipped with a permeable tube, which is formed of a proton exchange membrane that is permeable to the condensing vapor. An example of such a tube is a NAFION™ tube commercially available from Perma Pure LLC. The inlet (216) and outlet (236) of the permeable tube can be attached to the walls of the fluid storage tank (206). In use, a gaseous stream, for example, a particle-free, at room temperature air stream can enter in the permeable tube via an inlet (216). Then the vapor generated in the tank (206) is transferred to the inside of the permeable tube forming a vapor-containing gaseous stream, which exits from an outlet (236) of the tank (206). The vapor-containing gaseous stream is then introduced into the aerosol collection port (202) as the condensing fluid. The condensing fluid can be free of particles.

As discussed herein, the vapor in the condensing fluid condenses on the aerosol particles in the growth tube (204), the aerosol particles can act as nucleation sites forming droplets containing aerosol particles. The droplets grow in the growth tube forming a gaseous stream containing the grown droplets. Optionally, an orifice is located right before the exit of the growth tube (204) and ensures concentration of the grown droplets close to the central axis of a tubular member (266) that connects the growth tube (204) to a converging nozzle (248).

In FIG. 1A and FIG. 1B, at least a portion of the connecting tubular member (266) is surround by the fluid storage tank (206) such that a wall of the connecting tubular member (266) is heated by the surrounding fluid storage tank (206) to avoid vapor condensation on the wall of the connecting tubular member (266). The connecting tubular member (266) is optional. The growth tube (204) is in direct fluid communication with the converging nozzle (248). In this instance, the fluid storage tank (206) can be disposed next to the water vapor inlet (212).

In the converging nozzle (248), the gaseous stream containing the grown droplets that contain aerosol particles can be focused into a small aerosol particle beam. The length of the converging nozzle (248) can be 10 to 30 millimeters or 15 to 25 millimeters. The converging nozzle has an outlet for discharging the enlarged particles, and the outlet can have a diameter of 0.5 to 5 millimeters, 0.5 to 3 millimeters, or 1 to 2 millimeters.

The aerosol particles in the aerosol particle beam are then collected on a collection substrate (238) located downstream of the converging nozzle (248) for subsequent optical spectroscopic analysis. The collection substrate (238) can be heated to evaporate the condensed fluid upon impaction, and the heated condensed fluid can exit the device (200) via an aerosol outlet (258). Preferably the distance between the converging nozzle outlet and the collection substrate (238) is 1 millimeter to 10 millimeters or 2 to 8 millimeters. As the aerosol samples can be collected as a spot on the substrate, the aerosol collection port (202), the growth tube (204), the converging nozzle (248), and the collection substrate (238) together can be referred to a spot-sample mixing-flow condensation aerosol concentrator, namely, spot-sample MCAC.

The collection substrate (238) can have a cross-sectional profile that is circular, rectangular, or any shape that allows for efficient collection of the grown droplets that contain aerosol particles. In an embodiment, the collection substrate (238) is an electrode, for example a tungsten electrode. The electrode can be coated with silver nanoparticles, gold nanoparticles, copper nanoparticles, or a combination thereof. The thickness of the coating can be 1 nanometers to 100 nanometers. Preferably the collection substrate (238) is rotatable around the substrate axis to allow collection and measurement in from various independent angles. A collection substrate can also be a rotating disc (rotating around its azimuthal axis) or a large diameter cylinder (rotating around its longitudinal axis), that allows collection, analysis, and ablation of a collected particulate sample in different independent regions such that all three processes of collection, analysis, and ablation can be conducted independently and/or simultaneously.

With the converging nozzle (248), a miniscule aerosol deposition area can be attained as a spot with a diameter of 0.1 to 5 millimeters, 0.1 to 3 millimeters, or 1 to 2 millimeters on the collection substrate (238). This deposition area is small or large enough to permit coupling with optical spectroscopic or laser spectroscopy devices that can be used for analyzing the chemical composition of the aerosol particles.

Although FIG. 1A and FIG. 1B illustrate a device that collects grown droplets that contain aerosol particles on a collection substrate using a converging nozzle, it is appreciated that other techniques such as conventional inertial impaction, aerodynamic lens focusing collection, or electrostatic precipitation that may not involve condensational growth may also be used.

FIG. 2 illustrates a device (300) for direct liquid sample collection. The device includes two thermoelectric coolers (340) located on diametrically opposing sides of the growth tube (204) for enhanced cooling. A pair of heatsinks (310) and fans (320) are positioned on the opposite side of the coolers (340) for fast heat dissipation and higher cooling efficiency. The thermoelectric coolers (340), the heatsinks (310), and the fans (320) are operative to reduce a temperature of the growth tube (204) to less than 15° C., preferably 0° C. to 13° C., 0° C. to 10° C., or about 0° C. The “active” cooling of the growth chamber enhances the droplet enlargement, which is useful for higher flowrates, that can be easily collected through impaction. Additionally, the converging nozzle (248) can be coupled with an impactor (350) and a connector for an easily replaceable container (330) for the concentration of the aerosol-encapsulated water droplets. Collection of aerosols in a liquid solution can be accomplished with a flowrate of up to 15 liters per minute or up to 10 liters per minute. Nanoparticles with an initial aerodynamic diameter of 5 to 500 nm, 5 to 250 nm, or 5 to 50 nm can be enlarged in optical sizes of greater than 1,400 nm.

The collected aerosol particles as described herein can be analyzed by an offline analytical device. In an embodiment, the device (200) shown in FIG. 1A and FIG. 1B has an analytical component (208) which can be coupled to the fluid storage tank (206) or the growth tube (204) via the tubular member (266) and the converging nozzle (248).

The analytical component (208) can facilitate the characterization of the aerosol particles deposited on the collection substrate by an optical or laser spectroscopy. Examples of optical or laser spectroscopy include Raman spectroscopy, reflectance or absorption spectroscopy (in UV-VIS or infrared range), fluorescence spectroscopy, or emission spectroscopy. The analytical component (208) can comprise a probe (218) such as a Raman probe, an infrared probe, or a combination thereof. When the collection substrate (238) is a collection electrode, the analytical device (200) can further comprise a counter spark electrode (228) spaced from the collection electrode (238) to define a spark gap. When a voltage pulse is applied between the collection electrode (which can serve as a cathode 238) and the counter spark electrode (which can serve as an anode, 228), a pulsed spark discharge is generated to allow for chemical analysis of the deposited aerosol particles via spark emission spectroscopy (SES). This method has been referred to by various names such as spark microplasma spectroscopy or spark induced breakdown spectroscopy. Alternative plasma discharge can also be employed, such as a pulsed laser, a pulsed microplasma, an atmospheric or low-pressure radio frequency glow discharge, a laser, a laser-induced plasma, or a microwave-induced plasma.

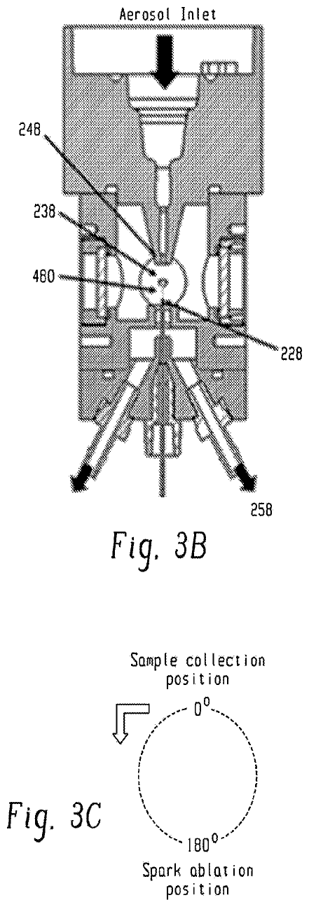

Referring to FIG. 3A and FIG. 3B, a device (400) for collecting and analyzing aerosol particles includes a converging nozzle (248) for discharging an aerosol stream containing aerosol particles; a collection substrate (238) located downstream of the converging nozzle (248) for collecting aerosol particles from the aerosol stream; a controller (268) coupled to the collection substrate (238) for controlling a rotation of the collection substrate (238); and a means for ablating the aerosol particles on the collection substrate (238). The converging nozzle (248) and the collection substrate (238) of device (400) can be the same as the converging nozzle (248) and the collection substrate (238) as described in the context of device (200). In an aspect, the converging nozzle is a multistage focusing nozzle having two to ten connected sections, wherein each section has a diameter, and the diameter decreases in a direction from an inlet of the converging nozzle to an outlet of the converging nozzle.

The means for ablating the aerosol particles on the collection substrate can comprise a means for generating a plasma discharge. Examples of the plasma discharge include a pulsed laser, a pulsed microplasma, a pulsed spark discharge, a laser, a radio frequency glow discharge, a laser-induced plasma, or a microwave-induced plasma. More than one plasma discharge may be used. In an aspect, the means for ablating the aerosol particles on the collection substrate can comprise a counter spark electrode (228) spaced apart from the collection substrate (238) to define a spark gap; and a means for applying a voltage pulse between the collection substrate (238) and a counter spark electrode (228) to generate a pulsed spark discharge that ablates the aerosol particles on the collection substrate. Optionally the device further comprises a Raman probe, an infrared probe, or a combination thereof.

Optionally the device (400) further comprises one or more components that facilitate the collection of aerosol particles. The components are not limited, and any suitable components can be used. In an aspect, the device (400) further comprises a fluid storage tank, an aerosol collection port, and a growth tube as described herein in the context of device (200). Aerosol outlet (258) discharges any excess fluid that leaves the collection substrate (238).

A method for analyzing aerosol particles using the device described herein comprises depositing the grown droplets containing aerosol particles discharged from the converging nozzle on the collection substrate and analyzing the deposited aerosol particles on the collection substrate with the analytical device.

Aerosols can also be analyzed by using a tandem spectroscopy for the same particulate deposit. Raman spectroscopy (or any other laser spectroscopy such as quantum cascade laser (QCL) reflectance spectroscopy) and spark emission spectroscopy (SES) can be used for chemical analysis of the aerosol sample by identifying the molecular species and for elemental analysis of aerosol.

In an aspect, a method for analyzing aerosol particles comprises collecting aerosol particles on a collection substrate. The collection substrate is then rotated to any desirable angle that allows independent and/or simultaneous spectroscopic analysis. The method of collecting the aerosol particles is not particularly limited. Optionally, the aerosol particles can be collected using a condensational growth method as described herein. The aerosol particles can be analyzed by more than one method. For example, a method for analyzing aerosol particles can comprise collecting aerosol particles on a collection substrate (238) and rotating the collection substrate to any desirable angle that allows independent and/or simultaneous spectroscopic analysis (238). The deposited aerosol particles may be analyzed using a first analytical method followed by rotating the collection substrate (238) and analyzing the deposited aerosol particles with a second, or third, or additional analytical method. One of the analytical methods can comprise ablating the deposited particles on the collection substrate creating atomic emissions and analyzing the atomic emissions. The other analytical method can comprise a Raman-based fluorescence, reflectance, or absorption measurement.

Referring to FIGS. 3A to 3C, in an embodiment, a method for analyzing aerosol particles comprises collecting aerosol particles on a collection substrate (238) at an original orientation. The collection substrate (238) is rotated to a new ablating orientation. The aerosol particles on the collection substrate (238) are ablated in the new ablating orientation, which optionally generates an atomic emission, which is then analyzed to characterize the aerosol particles on the collection substrate (238) if desired. The substrate can then be rotated back to the original orientation for subsequent collection of next sample of aerosol particles. The methods to ablate the aerosol particles are not particularly limited. For example, the aerosol particles on the collection substrate (238) can be ablated with a plasma discharge, and optionally the plasma discharge comprises at least one of a pulsed laser, a pulsed microplasma, a pulsed spark discharge, a radio frequency glow discharge, a laser, a laser-induced plasma, or a microwave-induced plasma. The collection substrate (238) can be rotated by any desired angle, for example 90° or 180°. In an aspect, the collection substrate (238) is rotated to face the counter spark electrode (228), which serves as the anode. A voltage pulse can be applied between the collection electrode (238) and the counter spark electrode (228) to generate a pulsed spark discharge (480) that ablates the aerosol particles on the collection substrate.

In another embodiment, the aerosol particles on a single substrate can be subjected to a plurality of ablation and analysis steps. The aerosol particles collected on the substrate may be subjected to a first ablation and then analyzed, followed by a second ablation and a second analysis.

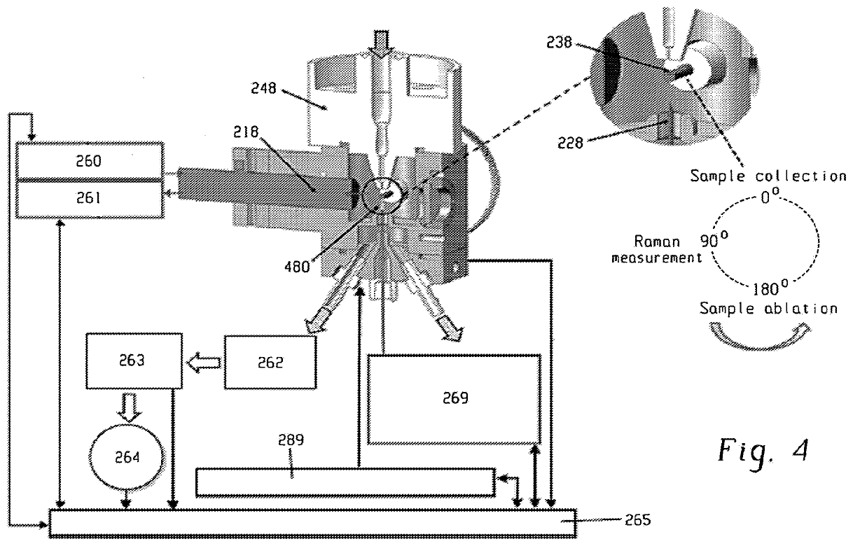

An exemplary method for analyzing aerosol particles as shown in FIG. 4 comprises collecting aerosol particles on a collection substrate, for example, depositing the grown droplets containing aerosol particles discharged from the converging nozzle (248) on the collection electrode (238); rotating the collection electrode (238) to face a laser beam generated from a laser source (260); irradiating the deposited aerosol particles with the laser beam, allowing a Raman, reflectance, or absorption measurement by a spectrometer (261) via a probe such as a Raman or IR probe (218); rotating the collection electrode (238) such that the deposited aerosol particles face the counter spark electrode (228); applying a voltage pulse between the collection electrode (238) and the counter spark electrode (228). The voltage pulse can generate a pulsed spark discharge (480) that ablates the aerosol particles on the collection substrate. Optionally ablating the aerosol particles on the collection substrate can generate an atomic emission, and the method further comprises analyzing the deposited aerosol particles with spark emission spectroscopy. Once the analysis is performed, the collection electrode (238) can be rotated to face the converging nozzle (248) for a second cycle of particle collection and measurement. The voltage discharge can be generated by a high voltage pulse generator (269). The operation of each component can be controlled using a microcontroller and data acquisition system (265) that are powered using an onboard DC power source (289). The aerosol flow can be driven by a pump (264) and can be maintained at a specific flow rate using a controller with feedback from a flowmeter (263). After aerosol particles are collected, the remaining particulate stream can be optionally filtered via a filter (262) prior to exhaust.

In an embodiment, a rotatable collection substrate (238) has three or four collection surfaces. Initially, none of the collection surfaces are deposited with any aerosol particles. Once the aerosol particles are collected on a first surface, the collection substrate (238) can be rotated to allow the aerosol particles to deposit on its second surface. Thus, the collection substrate (238) has a first and second or additional surfaces, each of which has aerosol particles deposited thereon, and yet an additional nascent/fresh surface without aerosol particles. In this instance, the method comprises: analyzing first deposited aerosol particles on the first surface of the collection substrate (238) with an optical spectroscopy such as Raman spectroscopy, reflectance or absorption spectroscopy (in UV-VIS or infrared range), fluorescence spectroscopy; and ablating the second aerosol particles on the second surface of the collection substrate (238) to analyze the second aerosol particles via atomic emission spectroscopy. The method can further comprises collecting aerosol particles on a third surface of the collection substrate. The method of collecting the aerosol particles is not particularly limited. The first and second aerosol particles can be collected from the same or different aerosol samples. Optionally, the aerosol particles can be collected using a condensational growth method as described herein but any other suitable collection methods can also be used. In other words, an aerosol sample can be collected on one collection surface, while simultaneously the sample collected on another surface (at 90 deg for example) is being spectroscopically analyzed; while the sample collected on yet another surface, facing the counter spark electrode is being simultaneously ablated and analyzed. Thus, this method allows for parallelization of three processes of i) particle collection, ii) spectroscopic analysis, and iii) ablation/removal of collected aerosol particles.

The method and device described here have several advantageous features with respect to personal aerosol sampling and aerosol chemical analysis. The method and device allow space-saving and miniature designs for easy integration into portable instruments. The device and method also allow near real-time measurement of aerosol samples. In addition, the device and method described herein allow aerosol sample collection as a small spot (for example 0.5 to 1.5 mm, or ˜1 mm diameter), followed by efficient interfacing with laser spectroscopic detection/analysis, followed by removal of collected sample, thereby improving the detection sensitivity to allow reduced aerosol sampling time and improved measurement time resolution. Moreover, the device and method allow continuous automatic measurement of aerosol samples. In the disclosed method according to an embodiment, each measurement cycle can include: i) collection of particles onto a substrate, ii) analysis using spectroscopic techniques, and iii) removal of samples and preparing for next measurement. All these three steps can be completed automatically, thus the method provide smooth near-real-time measurement in a hand-portable instrument. The device and methods further allow simultaneous elemental and molecular analysis of aerosol samples via various spectroscopic techniques. Vibrational spectroscopy, such as Raman spectroscopy and near or mid infrared spectroscopy provides molecular information, whereas atomic emission spectroscopy provides elemental composition of aerosol samples.

### Examples

### Spot-Sample MCAC

A small volume, medical nebulizer (Salter 8900 Series; Salter Labs, Arvin, CA, USA) was used to generate aerosols of sodium chloride for the characterization of the concentration device or spot-sample MCAC as described herein. A diffusion dryer was used in sequence to dry the aerosolized stream. Subsequently, the aerosol stream entered the Aerodynamic Aerosol Classifier (AAC; Cambustion Ltd, Cambridge, United Kingdom) to produce a monodisperse, nano- or microscale, particle-laden flow. Low flowrate through the AAC was selected, to attain higher resolution for the classification. Additional dry, particle-free, dilution air was provided, to reach the flow rate of 4 L min⁻¹ for the cold, particle-laden flow (aerosol flow). Simultaneously dry and purified-of-dust-particles-flow entered a saturator (fluid storage tank), and hot, water vapor-saturated stream (condensing fluid) was generated at the exit. The temperature in the saturator varied in the range of 70-85° C., and the flow rate of the hot, water vapor gas was regulated at 0.2-1.2 L/min.

Humidification of the aerosol stream was attained by the series MH-110-12F-4 (Perma Pure LLC, NJ, USA) for accomplishing complete saturation (RH=100%). In additional experiments, the relative humidity of the aerosol stream was regulated in the range of 11-100%. Downstream of the concentration device, the particle/droplet concentration of the mixture was measured by two optical counters. The first was the Ultrafine Water-based Condensation Particle Counter (UWCPC; model 3786, TSI Inc., Shoreview, MN, USA) which can provide a total particle concentration of particles with sizes down to 2.5 nm. Additionally, the Optical Particle Sizer (model 3330; TSI Inc., Shoreview, MN, USA) was used which classifies particles into 16 different channels with a minimum detectable size of 300 nm. Consequently, the condensation growth of particle sizes down to a few nanometers can be examined experimentally, by comparing the measurements of the two instruments.

The aerosol activation and growth efficiencies for spot-sample MCAC have been measured under the influence of five variables: (1) hot-to-cold flowrate ratio (Qₕ/Q_{c}), (2) saturator temperature (Tₛₐₜ), (3) aerosol stream's relative humidity, (4) aerosol size and (5) the aerosols' number concentration.

Finally, aerosol sample was accumulated on a heated collection flat surface to acquire the aerosol deposition area. In this set of experiments, polystyrene nanospheres were used, with a diameter of 20 and 150 nm (NIST Traceable Size Standards, Thermo Fisher Scientific) and fluoro-max green beads with a diameter of 1.9 μm (Thermo Fisher Scientific). The nano and micro-spheres were generated via aerosolization of liquid suspensions. The aerosol sample was collected on a flat heated surface at 90-100° C., and at the optimum nozzle-to-plate distance, found experimentally. Aluminum backed, carbon tape (Ted Pella Inc., Redding CA, US) was implemented for collecting the sample and for acquiring images using Scanning Electron Microscopy (SEM). The formed deposition's spot diameter has been calculated with the application of ImageJ software.

### Optimum Mixing Ratio

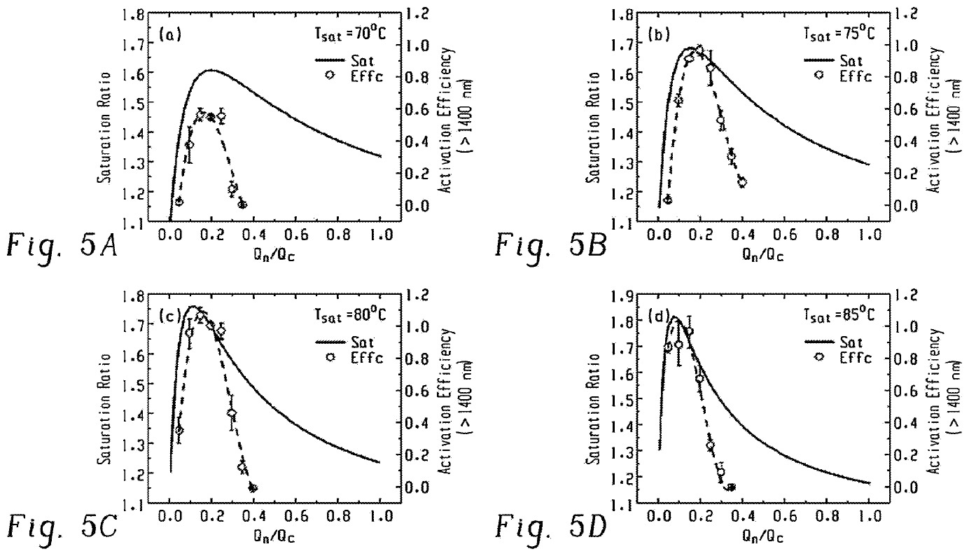

FIGS. 5A to 5D show variation of theoretically estimated saturation ratio of the mixed flow and experimentally measured activation efficiency of 25 nm sodium chloride particles as a function of the mixing ratio, at four saturator temperatures (70, 75, 80 and 85° C.). For all saturator temperatures tested, the saturation ratio exceeds unity following the mixing, which foreshadows particle activation and droplet growth. When water vapor was generated at 70° C., approximately 60% of the particles were activated and grown at a droplet diameter greater than 1.4 μm. When the saturator temperature was set at 75, 80 and 85° C., the particles were completely activated and grown up to droplet diameters greater than 1.4 μm.

According to FIGS. 5A to 5D, the saturation ratio and the activation efficiency are proportional to the temperature difference of the water vapor and the aerosol stream (ΔT). The greater the ΔT, the higher the saturation ratio and the activation efficiency. The minimum particle diameter that can be activated along with the final droplet size that can be attained depends on the saturation ratio absolute value, among other parameters. Good agreement is observed among the peaks of the calculated saturation ratio and the experimental activation efficiency. However, the corresponding mixing ratio to the saturation and/or the activation efficiency peak is different for the different ΔT. When the vapor temperature is 70° C., the saturation ratio approaches its maximum value at 1.6, corresponding to a mixing ratio of 0.2. In the experimentally measured activation efficiency curve, a plateau has been reached in the mixing ratio ranged at 0.15 to 0.25. That range includes the optimum mixing ratio value predicted theoretically. When the vapor temperature was set at 75, 80, and 85° C., the maximum saturation values calculated were 1.67, 1.74, 1.8 at a mixing ratio of 0.155, 0.115, 0.08, respectively. Thus, for the following experiments, different mixing ratios were selected based on the water vapor temperature, for optimum performance of the concentrator.

### Particle Diameter

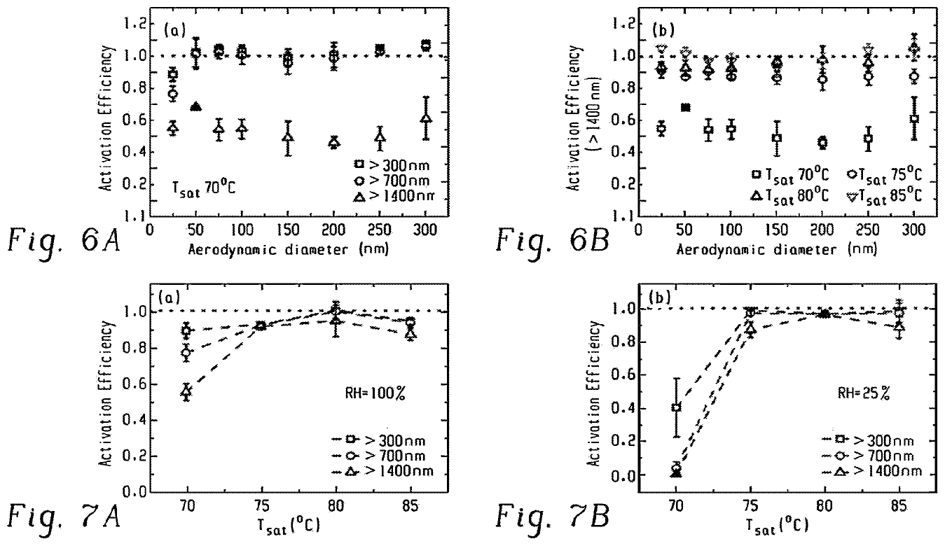

The activation efficiency of 25 nm-diameter NaCl particles introduced into the spot sample-MCAC when Tₛₐₜ=70° C., is shown in FIG. 6A. Activation efficiency based on three different droplet size fractions are shown: (i)>300 nm (ii)>700 nm and (iii)>1400 nm. Activation efficiency based on >300 nm fraction, is greater than about 90%, up to 50 nm diameter of NaCl seed particles, and nearly 100% above that. However, the activation efficiency drops below approximately 60%, if activation efficiency is based on >1400 nm droplet size fraction, indicating that a large fraction of the particles (˜55%), don't grow beyond 1.4 μm.

The activation efficiency based on >1400 nm fraction at various Tₛₐₜ of 70, 75, 80 and 85° C. is shown in FIG. 6B. Good activation efficiency, higher than 86%, 92% and 93% can be obtained at 75° C., 80° C. and 85° C., respectively for seed aerodynamic particle diameters in the range of 25 to 300 nm. Based on these measurements, a saturator temperature in the range of 75 to 85° C. was used in this study.

Wall and transport losses due to diffusion and inertial impaction in the spot sample-MCAC were calculated. Transport efficiency across the spot sample-MCAC is expected to be higher than 90% for nanoparticles with a diameter down to 2 nm. Negligible diffusive deposition is expected in mixing type condensation growth collectors (Kim et al., J. Aerosol Sci. 33 (10): 1389-1404 (2002) due to relatively high flow rates. The particle losses due to inertial deposition in the spot sample-MCAC were measured experimentally. Negligible losses (≤10%) were measured inside the growth tube for particle diameters up to 10 μm. When the converging nozzle with an outlet diameter of 1.7 mm is used, the total wall losses measured were less than 15% for particle diameters smaller than 5 μm and less than 20% for particle diameters smaller than 10 μm.

### Relative Humidity

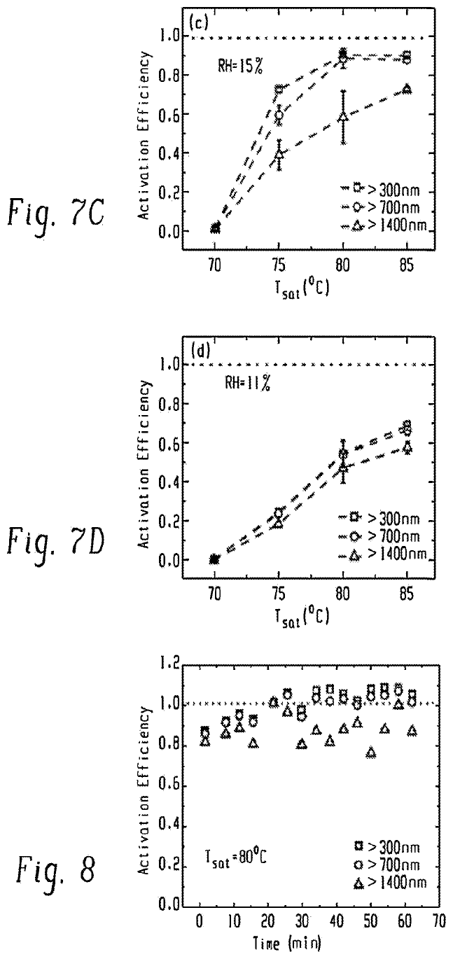

The performance of the spot sample-MCAC was tested, under various relative humidity values of the aerosol flow. As shown in FIGS. 7A to 7D, excellent performance of the spot sample-MCAC was observed when the aerosol-laden stream was fully saturated (RH=100%). The fully saturated aerosol stream contains more water mass than a partially saturated stream. Therefore, the stream mixture, generated by the mixing of the hot, vapor stream with the cold, aerosol-laden stream, contains more water mass which corresponds to higher partial vapor pressure; thus, higher supersaturation values are generated. Performance of the spot sample-MCAC was also good, when the relative humidity of the aerosol flow was 25%, at Tₛₐₜ=75, 80 and 85° C. However, performance was poor when Tₛₐₜ≤75° C., at RH below 25%, even when activation efficiency is based on >300 nm droplet size fraction.

When the relative humidity reaches the lowest value tested, which was 11%, partial activation is observed (68% and 57% activation efficiency based on >300 nm and >1400 nm droplet size fraction, respectively) even for the highest temperature in the saturator (Tₛₐₜ=85° C.). Thus, the optimum inlet relative humidity range can be 25-100%, for saturator temperatures above 75° C.

### Performance Stability

The activation efficiency of 25-nm-diameter NaCl seed particles promoted by the spot sample-MCAC as a function of continuous operating time is presented in FIG. 8. Complete activation and growth at detectable droplet diameters (>300 nm) were observed for up to at least sixty minutes. Activation efficiency remains constant and approximately close to 87% for final droplet diameters greater than 1400 nm.

The mixing-type condensation growth technique is based on instant, adiabatic mixing of a hot, vapor stream with a cold, aerosol-laden gas. The mixing chamber of the spot sample-MCAC is not actively cooled; however, despite the lack of active cooling, desired temperature difference between the hot and cold flows is maintained over extended period of operation, suggesting that the steady state temperatures of flows and mixing chamber walls are reached relatively quickly and do not diminish the performance. It is anticipated that longer operation should yield similar performance.

### Spot Sample Characteristics

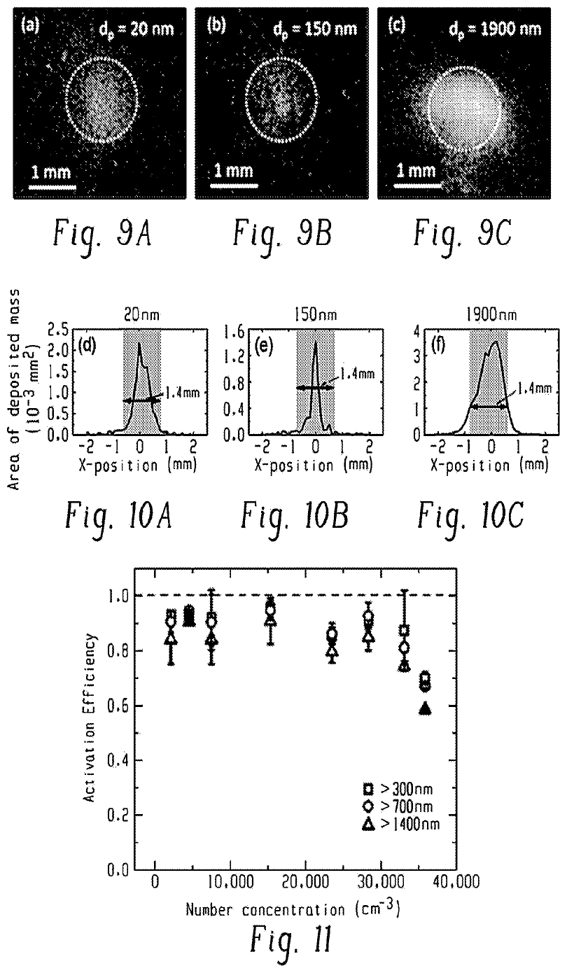

Experiments were conducted to probe the characteristics of the spot sample obtained from spot sample-MCAC using polystyrene latex particles as test aerosol. Particles were collected directly on an aluminum-backed carbon substrate that could be readily analyzed using scanning electron microscope to obtain spot diameter, and distribution characteristics. FIGS. 9A to 9C show scanning electron micrographs of spot samples obtained for test PSL aerosol with 20, 150, and 1900 nm particle diameter. The deposit diameter D90, defined as the diameter of a circle containing 90% of the deposited particles, was calculated from the radial position distribution of the projected area of the particles shown in FIGS. 10A to 10C. The D90 of the spot samples was independent of the seed particle diameter entering the spot sample-MCAC and was found to be 1.4 mm for all test PSL spheres. Spot sample characteristics of 150 nm diameter PSL nanospheres at a saturator temperature of 80 and 85° C. were also obtained. Similar deposition areas were formed, with a spot diameter of approximately equal to 1.4 mm and 1.2 mm for 80 and 85° C. The smaller spot deposit acquired when water vapor was generated at 85° C. is probably attributed to the higher saturation ratio generated, resulting in the formation of slightly larger droplets with a focal point closer to the nozzle exit.

Several tests were conducted to obtain the optimum nozzle-to-plate distance, whereby a similar, miniscule spot deposit is acquired for a broad diameter-range of PSL spheres. Large droplets are expected to have a focal point closer to the nozzle exit than smaller droplets, whereas at longer distances where small droplets converge closer to the central axis, bigger droplets are expected to cross the axis, resulting in dispersed spot deposits (Hari et al., Aerosol Sci. Technol. 41 (11): 1040-1048 (2007)). Therefore, the distance of 4 mm can be the optimum nozzle-to-plate distance that could serve the scope of this study.

The collected sample over a miniscule deposition area can be subsequently analyzed using laser spectroscopic methods, such as Raman spectroscopy, reflectance or absorption spectroscopy (in UV-VIS or infrared range), fluorescence spectroscopy, and emission spectroscopy, with increased sensitivity and enhanced detection limits (Wei et al. Sci. Rep. 7 (1): 1-8 (2017), J. Aerosol Sci. 150 (August 2020), Ann. Work Expo. Heal. 1-15 (2021); Zheng et al. J. Aerosol Sci. 104:66-78 (2017), Anal. Chem. 90 (10): 6229-6239 (2018)). Good sampling statistics are associated with effective sample micro-concentration, rendering increased mass density on a surface.

### Aerosol Number Concentration Effect

The effect of particle number concentration on the activation efficiency of 25-nm-diameter NaCl seed particles is presented in FIG. 11. The condensation aerosol concentrator can effectively activate approximately 85% of the particles and grow them into droplets at sizes greater than 1400 nm, for a number concentration range up to 3×10⁴ cm⁻³, while at 3.6×10⁴ cm⁻³ approximately 60% of the nanoparticles are expected to be collected. A similar trend is observed at droplet sizes greater than 300 nm and 700 nm. This indicates that while the number concentration increases, the activation efficiency decreases along with the growth efficiency. Thus, vapor condensation onto the particles can be assumed to initiate while the mixing occurs, which leads to temperature elevation, and subsequently to supersaturation ratio decrease.

### Counting Statistics for Fiber Concentration Measurement

Fiber counting through Phase Contrast Microscopy (PCM) is often used for the quantitation of fiber concentration collected on a substrate. Fiber collection on 25-mm filters is proposed by NIOSH method 7400 for PCM analysis (NIOSH 2019); however, other collection techniques can be employed for fiber sample concentration in a small spot deposit that can reduce the counting uncertainty. Comparison of estimated Poisson counting statistics for fiber concentration measurements using PCM can be promoted for various collection methods, such as the spot sample-MCAC, the Sequential Spot Sampler and the filter-based collection method. Sampling of a large number of fibers, N, that are to be counted can reduce the counting uncertainty (σ%=1√N). The NIOSH method 7400 recommends a substrate area for microscopy analysis of 0.785 mm² (Am), and a fiber density on the microscopy analysis area in the range of 100-1300 mm⁻², for optimum and unbiased counting (σ=2.8-10%; NIOSH 2019). Assuming a fiber concentration of 0.1 cm⁻³ (Cf), the estimated sampling time (tc) needed to achieve the target counting uncertainty of 3-10% was calculated:

tc=N Ad/Am Cf Qη

where Ad is the spot deposit area of each collection technique, Q is the sample flow rate employed in each collection method, and n is the collection efficiency. The area of the spot sample generated from spot sample-MCAC was about 1.54 mm², whereas the effective area over which the sample was collected using the Sequential Spot Sampler and the 25-mm filter was 0.785 and 385 mm².

The spot deposits formed by the spot sample-MCAC, and the Sequential Spot Sampler improved the sampling time—for the same target counting uncertainty (σ=3-10%)—or the counting uncertainty—for the same sample collection time-approximately two to three orders of magnitude compared to the 25-nm filter collection. To achieve a target uncertainty of 3%, approximately 6 min of fiber sampling are required for the spot sample-MCAC, 8 min for the Sequential Spot Sampler and 2725 min for the 25-nm filter collection.

### Liquid-Sample MCAC

Following every collection run, the impactor along with the collection vial was removed from the collector for the sample acquisition. The impactor was rinsed with isopropyl alcohol, and the suspension was then vacuum-filtered.

### Saturator Temperature Effect

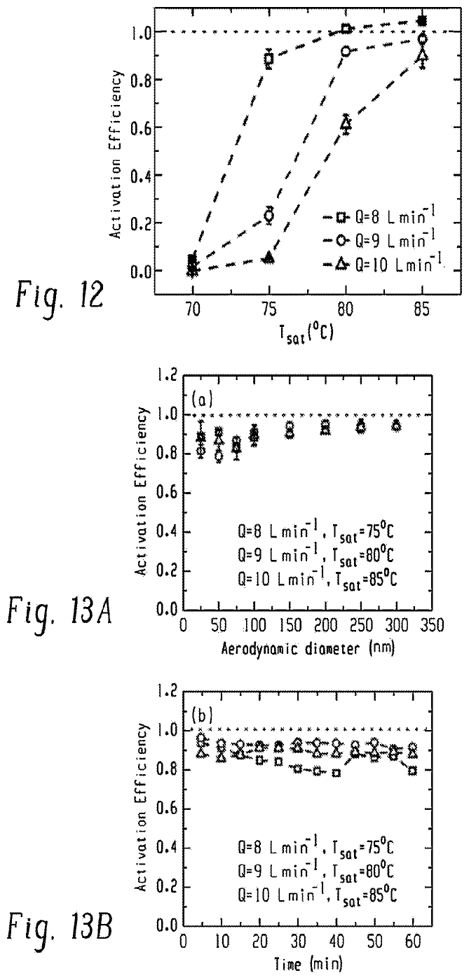

Firstly, the effect of the temperature in the saturator, where the hot water vapor is generated, on the detection efficiency of grown droplets encompassing sodium chloride particles, was evaluated (FIG. 12). The highest detection efficiency (>90%) was obtained when the highest saturator temperature was used (85° C.), for all aerosol flow rates. Good detection efficiency (>89%) was measured when an aerosol flow rate of 8 L min⁻¹ was employed, and the saturator temperature was set at 75° C. or higher.

When higher aerosol flow rates were employed, higher saturator temperatures were required for nearly complete detection. Particularly, when an aerosol flow rate of 9 L min⁻¹ was used, a detection efficiency of 92% or greater was achieved for a saturator temperature set at 80° C. or higher. Additionally, when an aerosol flow rate of 10 L min⁻¹ is used, a detection efficiency of 90% was measured only when the vapor temperature was equal to 85° C.

The correlation among the aerosol flow rate, the saturator temperature, and the efficiency of the liquid-sample MCAC that were obtained here, can be attributed to the residence time of the particles at the interior of the collector. Particularly, it has been showed that lower vapor temperatures can be used when lower aerosol flow rates are used. For instance, when 8 L min⁻¹ of aerosol flow rate is implemented and the generated vapor's temperature is set at 75° C., the total throughput flowing through the growth tube is 9.2 L min⁻¹ with a particle residence time of 0.19 sec. On the other hand, a sample flow rate of 10 L min⁻¹ require instant mixing with 1.5 L min⁻¹ of hot vapor, rendering a residence time of 0.15 sec, that is found to be not adequate for aerosol activation and droplet growth at optical sizes greater than 1400 nm.

### Particle Diameter and Operation Time Effect

The particle diameter effect on the performance of the liquid-sample MCAC was also examined (FIG. 13A), for three aerosol flow rates: 8, 9 and 10 L min⁻¹. The saturator temperature used for each aerosol flow rate, was the minimum temperature required for nearly complete detection (Tₛₐₜ=75° C. for Q=8 L min⁻¹, Tₛₐₜ=80° C. for Q=9 L min⁻¹, and Tₛₐₜ=85° C. for Q=10 L min⁻¹). Detection efficiency greater than 80% was obtained for the minimum particle diameter generated, 25 nm, and it can reach values greater than 90% for greater particle diameters, irrespective of the aerosol-laden flow rate.

Due to the temperature differentials used in the collector, and the necessity for adiabatic mixing of the hot vapor with the particle-carrier stream, the effect of the operation time of the liquid-sample MCAC on the collection efficiency was also evaluated (FIG. 13B). The collection device performed well up to sixty minutes of operation, collecting sodium chloride aerosols with an aerodynamic diameter of 100 nm. The detection efficiency measured was approximately equal or greater than 80%, across time, particularly for higher aerosol sample flow rates. Therefore, the collector can be operated continuously for at least sixty minutes, without heat being transferred through the different sections contained within the collector, that could render deteriorated collection efficiencies.

### Growth Tube Temperature Effect

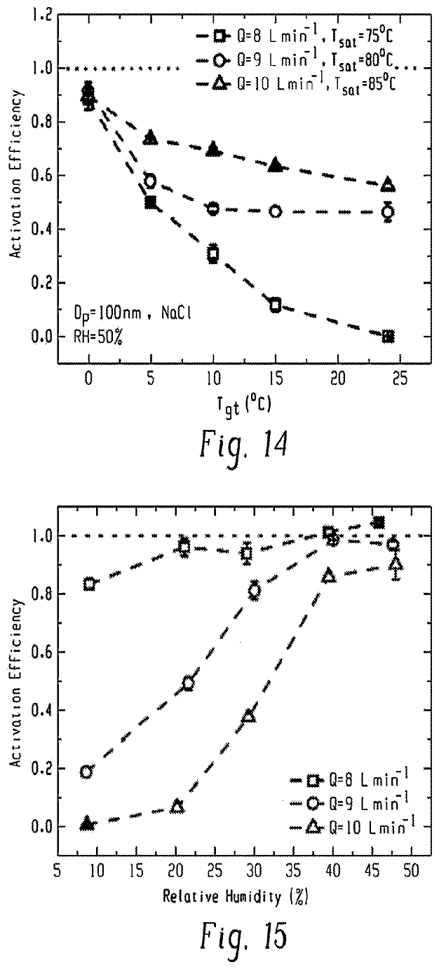

The effect of the growth tube temperature (Tgt) on the detection efficiency obtained through the liquid-sample MCAC is shown in FIG. 14. The highest detection efficiency was measured at the lowest temperature set on the growth tube wall, at 0° C., as anticipated, for all particle flow rates employed. However, at lower aerosol sample flow rates, i.e. 8 or 9 L min⁻¹, the effect of the growth tube temperature was greater, than when higher aerosol sample flow rate is implemented (10 L min⁻¹). This is probably attributed to the lower saturator temperature used when the lower flow rates were employed (Tₛₐₜ<85° C.). The particle activation and droplet growth efficiency, and therefore the detection efficiency, is proportional to the saturation ratio value reached at the mixing-point of the cold, aerosol-laden flow with the hot, vapor stream. The saturation ratio is only dependent on the temperature differential of the two streams, and the vapor-to-hot flow ratio, albeit not the individual flow rates of the streams; thus, the highest detection efficiency is expected to be obtained when the highest saturator temperature is used (Tₛₐₜ=85° C.).

### Relative Humidity Effect

The detection efficiency of the enlarged droplets detected by the OPS as a function of the relative humidity of the input aerosol flow is shown in FIG. 15. Higher supersaturation ratios can be attained when the water vapor content of the aerosol flow is higher; thus, better particle activation and growth efficiency is expected at higher relative humidity values of the aerosol-laden flow. Moreover, an inversely proportional association is observed among the input flow rate used and its relative humidity values: Lower inlet aerosol-laden flow rates render higher detection efficiency even at low humidity levels. At an aerosol flow rate of 8 L min⁻¹, the detection efficiency is greater than 90% for relative humidity values of 20% or higher. Additionally, good detection efficiency is attained (greater than 80%), even at a relative humidity value of 9%.

Excellent detection efficiency is obtained at an aerosol flow rate of 9 L min⁻¹, down to 30% relative humidity. When the highest aerosol flow rate is implemented 10 L min⁻¹, good detection efficiency is obtained at relative humidity values of 40% or higher. The efficiency can decrease at lower relative humidity values.

### Number Concentration Effect

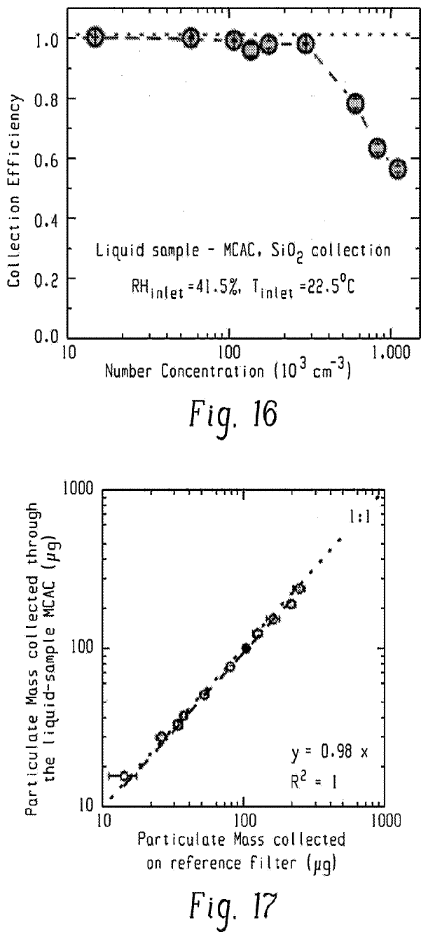

Respirable silica was generated and used for evaluating the impact of the particle number concentration on the liquid-sample MCAC (FIG. 16). Complete airborne particle collection is observed in particle number concentrations up to approximately 1.8×105 pcs cm⁻³. Bigger respirable silica particle diameters that contribute the most in the total particulate mass of the sample, are efficiently collected up to high concentrations.

### Particulate Mass Collection

The particulate mass collection attained via the liquid-sample MCAC was measured and compared with the conventional particle collection method of air filtration (FIG. 17). In general, good agreement is observed between the two particle collection techniques, with a small deviation of approximately 7% (FIG. 17). The linear fit curve that corresponds to the experimental data was plotted, and the slope was found to be equal to 0.93 with high linearity (R²=0.997).

Deviations among the collected masses measured through the liquid collector and the filter can be attributed to the insolubility of the collected aerosol used here, the respirable silica, the activation and growth efficiency that can be attained in the liquid collector, particle or droplet losses that may occur in the condensational growth apparatus and/or particulate sample losses due to sample deposition from the suspension to the filter. The high agreement among the two collection techniques shows that the liquid collector device developed here can be used successfully for aerosol collection directly as a liquid suspension.

### Measurement of Aerosols in Workplace Atmospheres

### Experimental Methods

In this section, a method to detect multi-component aerosols in workplace environment is discussed. A field-portable instrument based on Raman spectroscopy with near real-time measurement of aerosols has been presented in this section.

### Instrument Setup

A portable prototype Raman Aerosol Spectrometer as shown in FIG. 4 is used. The components in the instrument are electronically controlled using an embedded microcontroller and a data acquisition system allows for automated measurements.

### Aerosol Collection

Airborne particles are focused onto the Tungsten electrode through a converging nozzle for a predetermined amount of time. Two types of nozzles have been used for the particulate deposition: (i) A multi-stage nozzle (MSN), and (ii) a single stage nozzle (SSN), with outlet diameters of 0.8 mm and 0.5 mm, respectively.

For the MSN and SSN, flow rates of 21/min and 0.5l/min were used, respectively.

The electrode (1.5 mm in diameter and 56 mm in length) is held by a geared stepper motor (Model 42M048C2B-R21, Portescap, West Chester, PA) with a rotational step size of 0.75°. One end of the cylindrical electrode is machined to create a 6 mm planar surface for particulate aerosol collection. The aerosol flow through the aerosol collection system is driven by a miniature pump (Allied Motion (Premotec) BL30 EB) and was maintained at a specific flow rate using a proportional-integral-derivative (PID) controller with feedback from a flowmeter. Remaining particulate stream is filtered prior to exhaust.

### Raman Spectrometer

After electrode rotation by a predetermined angle, for example 90°, to another orientation of the planar collection surface with respect to the nozzle axis, the particulate sample deposited on the electrode is analyzed using the Raman system that consists of an integrated Raman probe, a laser source, and a spectrometer (Model WP 785, Wasatch Photonics, Morrisville, NC). The Raman probe is integrated with the ACS such that the excitation laser is incident perpendicular to the planar collection surface of the electrode. The working distance between the probe and the collection surface is 22 mm. The laser source has an excitation wavelength of 785 nm, a maximum power of 450 mW, and a focal spot diameter of 120 μm. The spectrometer measures the Raman intensity over a wavenumber range of 235-2000 cm⁻¹ at a spectral resolution of 6 cm⁻¹.

Raman spectra were collected at the maximum power (450 mW) of the excitation laser. A detector integration time of 3 sec was used to optimize the signal-to-noise ratio for the materials use in this study. Dark and blank spectra subtraction and baseline correction were applied to each spectrum. For the baseline removal, the canonical rolling-circle filter (RCF) algorithm coupled with a Savitzky-Golay filtering step conjunctly known as the Savitzky-Golay Adaptive Rolling Circle Filter (SCARF) was adapted. A line drawn tangentially to the background-corrected curve on each side of the peak was used as a baseline for calculating the peak height at a specific Raman frequency shift.

### Pulsed Spark Generation System

After the Raman analysis, the electrode is rotated a further 90° and the particulate sample deposited on the electrode is ablated using a sequence of pulsed spark discharges generated by a high voltage pulse generator (Firefly, Cascodium Inc., Andover, MA) with an output energy of 200 mJ/pulse. The sample-free electrode is subsequently available for the next cycle of measurement.

The overall measurement scheme used in the study consists of the following cyclical steps: (i) collection of particles on the electrode for a predetermined time, (ii) rotation of the electrode by 90° counterclockwise (iii) acquisition of Raman spectra at predetermined signal integration time followed by spectral analysis and classification to determine aerosol mass, (iv) rotation of the electrode by another 90° counterclockwise (v) sample removal via ablation, and (vi) return to the initial position.

In addition, the instrument can perform tandem Raman-Spark emission spectroscopy analysis. This method consists of the collection of aerosolized particles onto a small electrode tip followed by ablation of particles by the spark generated using a high voltage (HV) pulse generator. The optical emission from excited atomic and ionic species in the spark induced plasma was collected using a broadband spectrometer (200-900 nm wavelength range and 0.1 nm resolution; LIBS 2500 Plus; Ocean Optics Inc.; Dunedin, FL) for spectrochemical analysis.

### Instrument Calibration

The aerosol for the calibration was generated from aqueous suspensions using a Collison nebulizer (BGI, Butler, NJ, USA), and subsequently passed through a diffusion dryer (TSI Inc., Shoreview, MN, USA). Aqueous suspensions of α-quartz respirable crystalline silica (RCS) material, Min-U-Sil 5, and rutile titanium dioxide (C35R4, DuPont chemicals, Wilmington, Delaware) were prepared in ultrafiltered deionized water (CAS 7732-18-5, Thermo Fisher Scientific, Rochester, NY, USA). For measuring RCS, Min-U-Sil 5 was used instead of a NIST standard reference material, SRM 1878, since a large quantity of the analyte was needed for development of the calibration curve. Note that SRM 1878 is based on Min-U-Sil 532. The aerosol generated from the nebulizer at an air flow rate of 5l/min was split between the quartz crystal microbalance micro-orifice uniform deposition impactor (QCM MOUDI impactor model 140, TSI Inc., Shoreview, MN, USA) and the Raman instrument. For collection of analytes on the electrode using the MSN, a flow rate of 21/min was used, while using the SSN, a flow rate 0.5l/min was used. Concomitantly, the nebulized aerosol was supplied to the QCM at 0.5l/min. To compensate for the operating flow rate of 101/min for the QCM impactor, the nebulized aerosol was diluted with filtered air at 9.5l/min regulated using a mass flow controller. The QCM impactor measures the mass of the particulate aerosols with aerodynamic sizes ranging from 0.045 μm to 2.44 μm (≤PM2.5) in real-time. For the quartz and titania analytes aerosolized in this study, this PM2.5 fraction accounts for >90% of the total mass. The size-based distribution of the mass concentration was estimated from the Aerodynamic Acrosol Classifier (AAC; Cambustion Ltd, Cambridge, United Kingdom) and a condensation particle counter Ultrafine Water-based Condensation Particle Counter (model 3786 UCPC; TSI Inc., Shoreview, MN, USA) operated in tandem. The total mass of the aerosol is measured by the QCM for a specific collection duration on the electrode prior to Raman spectral acquisition in the instrument.

### Quantification of Hazardous Aerosols

### Quartz RCS in Fracking Dust

Fracking dust samples were collected at an oil and gas extraction site. This dust was aerosolized using nebulization prior to collection in the Raman instrument.

Before the deposition of the aerosol, a thin layer of silver nanoparticles (576832, Sigma-Aldrich Inc., Atlanta, GA) was coated on to the electrode. Fracking dust samples were then collected on the electrode over a duration of 2, 3, and 4 hours followed by the spectral acquisition. In addition, X-ray diffraction (XRD) analysis of the fracking dust samples deposited on silver filters with 25 mm diameter and 0.45 μm pore size (Cat. No. 225-1802, Lot. No. 20191202, SKC Inc. Pennsylvania, USA) was performed on the Empyrean diffractometer (Malvern PANalytical B.V., Almelo, Netherlands) according to the NIOSH method 750041 to determine the concentration of quartz RCS. Bulk fracking dust samples were also imaged using a Phenom XL 12 SEM (Thermo Fisher Scientific, Waltham, MA, USA) with a backscattered electron (BSE) detector. The micrographs were analyzed using MIPAR™ software version 3.4.2 to determine particle size distribution.

### Titanium Dioxide in a Mixture

A 5:1:1 mixture by mass of titanium dioxide, Arizona road dust (ARD), and diesel particulate matter (DPM) was prepared. The mixture was aerosolized using nebulization prior to collection on the electrode in the Raman instrument. The aerosol was collected over a duration of 10 sec to 60 sec at increments of 10 sec.

### Detection of Common Hazardous Aerosols

Other aerosols of interest in workplace atmospheres such as elemental carbon-based compounds and toxic metals such as chromium VI (hexavalent chromium) were assessed using the Raman instrument. Carbon-based compounds such as single-walled carbon nanotubes (P7-SWNT; Carbon Solutions Inc., Riverside, CA), DPM (NIST SRM 2975; U.S. Department of Commerce, NIST, Gaithersburg, MD), and chromium VI oxide (675644, Sigma-Aldrich Inc., Atlanta, GA) were nebulized and then collected on the electrode. The collected samples were analyzed to ascertain whether these hazardous aerosols could be detected by the Raman instrument.

### Calibration Curves for Quartz RCS and Rutile Titania

For crystalline silica, the peak Raman shift at 465 cm⁻¹ is associated with the Si—O—Si symmetric stretching-bending modes. The ordinate for the quartz calibration curve in FIG. 17A shows the peak height determined by subtracting the baseline Raman intensity from the peak intensity at 465 cm⁻¹. The abscissa for the calibration curve contains the corresponding crystalline silica mass obtained from the QCM impactor. The vertical error bar for each data point in FIGS. 17A and 17B represents the standard deviation about the mean obtained by averaging over three measurements.

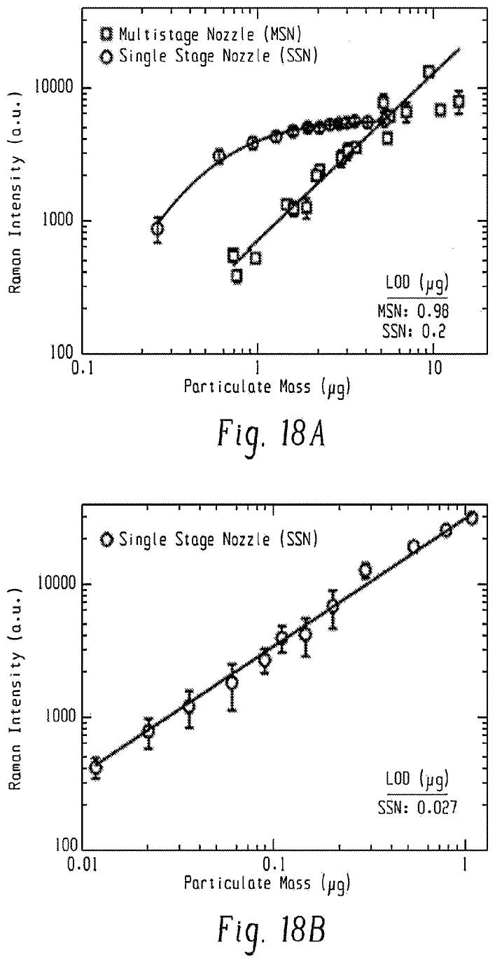

FIG. 18A shows the calibration curves using the MSN (for mass loadings below 20 μg) and SSN (for mass loading below 5 μg). MSN has a larger opening; therefore, it enables collection of the larger quantity of analyte. The SSN has a smaller opening leading to lower amount of detectable analyte. COMSOL™ simulations of particles with different aerodynamic sizes collected through the nozzles reveal that while using MSN at 2l/min, a tighter spot can be obtained. However, a significant fraction of the particles is concentrated on the periphery than at the center, resulting in a higher limit of detection (LOD). Whereas the particles are more spread-out during collection through the SSN at 0.5l/min, the majority fraction is deposited in the center. The nonlinearity at high mass loadings for collection through the SSN was attributed to increasing thickness of the spot sample. The Raman signal saturates at a certain thickness of the deposit beyond which there is no increase. Using SSN, the nonlinear portion of the curve up to 1 μg appears to provide acceptable uncertainty.

The 3-sigma criteria defined by the International Union of Pure and Applied Chemistry (IUPAC) was used to calculate the LOD. At a signal integration time of 3 sec, the mass LOD was 0.98 μg and 0.2 μg for crystalline silica using the MSN, and SSN, respectively. These detection limits are significantly lower compared to that of the standard XRD method 41 (5 μg) and can allow short-term as well as full-shift measurement below the new permissible exposure limits.

Two types of nanosized titanium dioxide, anatase and rutile, are widely used in industry, commercial products and biosystems. The Raman spectrum of rutile TiO₂ which has peaks at 445 cm⁻¹ and 610 cm⁻¹. The Raman system can also measure other polymorph of titanium dioxide, anatase, which has peaks at 390 cm⁻¹, 510 cm⁻¹ and 640 cm⁻¹. Using SSN, the TiO₂ (rutile) powder was collected and analyzed using the Raman spectrometer. The calibration curves were constructed by plotting the peak height at 445 cm⁻¹, after baseline correction, as a function of the corresponding TiO₂ mass obtained from the QCM impactor as shown in FIG. 18B. The vertical error bar around each data point in FIG. 18B represents the standard deviation around the mean obtained by averaging over three replicate measurements.

The 3-sigma criteria defined by the International Union of Pure and Applied Chemistry (IUPAC) was used to calculate the LOD. At a signal integration time of 3 sec, the mass LOD was ˜0.027 μg for TiO₂ (rutile). The drastic improvement in sensitivity of the system described herein is accomplished by collection of particles over a small spot in ACS, which allows effective coupling with the Raman excitation laser. The LOQ for the anatase polymorph is expected to be like the LOQ observed for the rutile polymorph (˜0.09 μg) since the sensitivity to Raman analysis for both the polymorphs is similar. This demonstrates the superior sensitivity of the instrument to detect different polymorphs of a particular analyte when they have different Raman peaks.

### Quantification of Particulate Aerosols in Field Samples and Mixtures

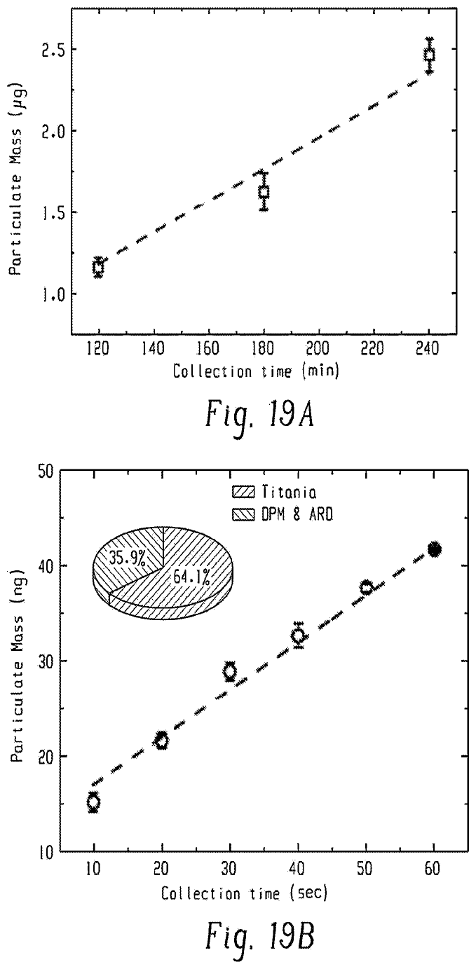

FIG. 19A estimates the mass of quartz RCS in the fracking dust that was aerosolized and collected on the electrode for 2, 3, and 4 hours using the MSN. Using the calibration curve in FIG. 18A, the RCS content was determined. At least two hours of collection was required for the RCS content in the sample to be above the LOD. Longer collection durations were expected since only a small fraction of the bulk fracking dust comprised of PM2.5 particles. The RCS content in bulk fracking dust was estimated to be 60 (+20) % from the quartz SRM1878b calibration curve. Although not attempted, it is expected that the percentage of RCS in fracking dust from the Raman instrument be comparable to the XRD method, if fluorescence can be minimized.

FIG. 19B shows the mass of titania in the aerosolized mixture of titania (5 parts), ARD (1 part), and DPM (1 part) that was collected at 10 sec increments using the SSN. Using the calibration curve shown in FIG. 18B, the titania content was determined. A minimum of 30 sec collection was required for the titania content in the mixture to be above the LOD. The composite Raman spectrum from the mixture contained the signature peaks for TiO₂, and the carbon ‘D’ and ‘G’ modes for DPM. It is possible to detect different components simultaneously using the Raman instrument. The pie-chart in FIG. 19B shows that the titania content in the mixture was 64.1% by mass based on the Raman measurements which is like the titania mass (71.4%) in the prepared mixture. The slight discrepancy is expected since the generated aerosol would not have the same ratio of components as the prepared mixture.

### Assessment of the Near-Real Time Measurement Capability of the Instrument

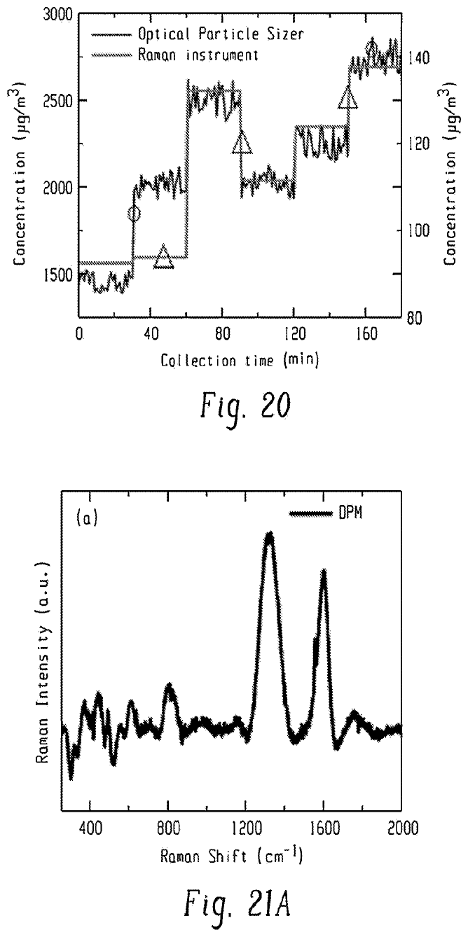

Test aerosols of quartz RCS (Min-U-Sil 5) were used to assess the short-term measurement capability of the disclosed Raman instrument. FIG. 20 shows a continuous measurement of the mass concentration of a simulated transient quartz aerosol. The concentration of the test aerosol was intentionally varied periodically to mimic transient exposure over 180 min. The total aerosol mass concentration was monitored through the Optical Particle Sizer (Model 3330, TSI Inc., Shoreview, MN, USA). Consecutive 30 min spot samples were collected for Raman analysis. This collection time was sufficient to measure RCS above LOQ of the Raman method. In FIG. 20, the curve with o shows the real-time total aerosol mass concentration air concentration measured by the TSI OPS. The curve with A shows measured RCS concentration using the Raman instrument. As can be seen from FIG. 20 the transient measurement capability of the Raman instrument is in a good agreement with the TSI OPS measurements. These measurements clearly demonstrate the capability of the disclosed approach to obtain continuous, automated near real-time measurements.

### Elemental Carbon-Based Materials and Chromium VI

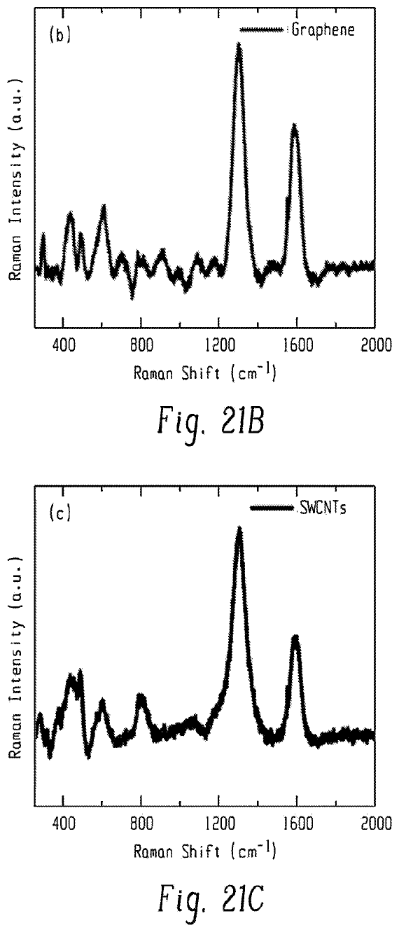

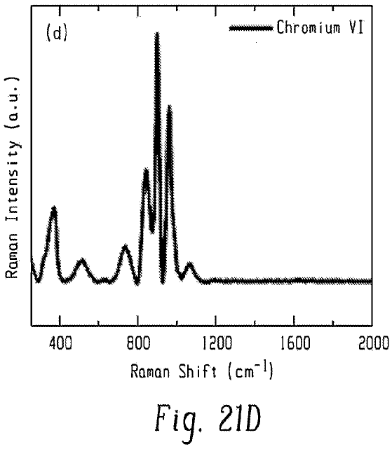

FIGS. 21A, 21B, and 21C show the spectra of carbon-based compounds using the Raman instrument. All carbon-based materials irrespective of whether they are amorphous or crystalline will exhibit characteristic first order peaks at approximately 1380 cm⁻¹ and 1580 cm⁻¹ which are commonly referred to as the D and G bands, respectively. The G band occurs because of the stretching of a bond connecting two sp2 sites arranged in either olefinic chains or aromatic rings. The D band occurs due to the breathing vibration of sixfold aromatic rings. FIG. 21A shows the characteristic Raman spectrum of DPM which shows the two peaks associated with the D and G bands. Similar peaks were observed for graphene as shown in FIG. 21B, and single-walled carbon nanotubes (SWCNTs) in FIG. 21C. The SWCNTs also exhibit an additional peak known as the radial breathing mode (RBM; 166 cm⁻¹). However, this peak could not be detected due to limitation in the range of the detector (235 to 2000 cm⁻¹).

Chromium exists in nine valence states (ranging from −2 to +6). Among them, Cr (VI) and Cr (III) are most predominant in the environment because of their stability. The Cr (VI) compounds are carcinogenic and mutagenic and could cause serious injury to living organisms, including allergies, irritations, and respiratory track disorders. FIG. 21D shows the characteristic Raman spectrum of Cr (VI) which has a peak at 894 cm⁻¹. The LOD for the Cr (VI) using the Raman instrument is expected to be ˜20 ng to ˜30 ng (like rutile titania) since it is extremely sensitive to the Raman signal.

### Uncertainty Analysis

The relative standard deviation in the aerosol sampling flowrate of the pump in the instrument was estimated to be between 5% to 10%. Misalignment of the electrode during the collection and measurement can lead to less amount of analyte being detected by the laser. Therefore, the rotating motion of the electrode was repeated 100, 500, and 1000 times to check if any steps were missed from the stepper motor. Negligible uncertainty was detected from the rotation action of the electrode. Further, the electrode was intentionally misaligned by ˜5° to determine the uncertainty. It was found that such misalignment could lead to an uncertainty of 10% to 15%. Overall, the relative uncertainty of Raman instrument for measurement of aerosol concentration, deduced from the standard error of mean concentration measured over the largest time used in this study, ranged from 8% to 15%. Through propagation of uncertainties using the equation, m=CₜₒₜₐₗQt, the relative uncertainty associated with mass measurement was estimated to range from 12% to 18%.

The measurements discussed herein clearly demonstrate the capability of Raman instrument to obtain continuous, automated near real-time measurements of a variety of aerosols. Few studies that have previously reported real-time measurement of aerosols using Raman spectroscopy. Raman scattering is orders of magnitude weaker than the elastic scattering, and probing aerosols in a suspended state would result in extremely poor sampling statistics and detection limits (typically >1 mg/m³). Further, large lasers with a high-power density were required along with precisely designed optics to generate a focused spot to analyze suspended particles in the aerosol, making this approach unsuitable for field-portable instrumentation. The Raman instrument presented in this study provides superior time resolution and detection limits, and it is portable.

The portable Raman instrument is useful for making quick, on-site measurement of short-term exposures that are not possible using the laboratory techniques such as XRD method. Spot sample collection is necessary to achieve low detection limits; however, it may not be necessary if higher detection limits or full-shift collection are adequate.

One advantage of the disclosed approach is negligible or reduced sample heating due to efficient heat transfer to the metal electrode of aerosol collection system.

The study shows that the Raman instrument, has the potential for broader adoption as an on-site or in-field method by non-expert professionals (those not trained in Raman spectroscopy). The approach is also cost-effective, allowing users to collect short-term samples if needed or collect several samples. By using the instrument judiciously, it may be possible to design an effective aerosol exposure monitoring program which can help reduce the number of compliance samples and the analysis costs thereof. If the measurement uncertainties using the Raman instrument are in an unacceptable range for a particular workplace sample, the technique can still provide semi-quantitative or qualitative measurements quickly onsite, which can be useful in some applications such as assessment of engineering controls.

The terms “a” and “an” do not denote a limitation of quantity, but rather denote the presence of at least one of the referenced item. The term “or” means “and/or.” The open-ended transitional phrase “comprising” encompasses the intermediate transitional phrase “consisting essentially of” and the close-ended phrase “consisting of.” Claims reciting one of these three transitional phrases, or with an alternate transitional phrase such as “containing” or “including” can be written with any other transitional phrase unless clearly precluded by the context or art. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on its scope unless otherwise claimed. No language in the specification should be construed as indicating any non-claimed element as essential to the practice of the invention as used herein. Unless defined otherwise, technical and scientific terms used herein have the same meaning as is commonly understood by one of skill in the art to which this disclosure belongs.

1. A device for collecting and analyzing aerosol particles, the device comprising:
a fluid storage tank for generating a condensing fluid comprising a vapor, the condensing fluid having a first temperature;
an aerosol collection port having
a vapor inlet for receiving the condensing fluid generated from the fluid storage tank, and
an aerosol inlet for receiving an aerosol stream containing aerosol particles,
the aerosol stream having a second temperature that is lower than the first temperature,
wherein the condensing fluid is mixed with the aerosol stream in the aerosol collection port producing a mixed stream;
a growth tube configured to receive the mixed stream from the aerosol collection port
and condense the aerosol particles to form a gaseous stream containing grown droplets that contain aerosol particles; and
a converging nozzle in fluid communication with the growth tube, the converging nozzle
focusing the condensed fluid into an aerosol beam containing the grown droplets.

2. The device of claim 1, wherein the converging nozzle has an outlet for discharging the grown droplets that contain aerosol particles, and the outlet has a diameter of 0.5 to 5 millimeters, 0.5 to 3 millimeters, or 1 to 2 millimeters.

3. The device of claim 1, further comprising a tubular member that connects the growth tube to the converging nozzle, wherein at least a portion of the tubular member is surround by the fluid storage tank such that a wall of the tubular member is heated by the fluid storage tank to avoid vapor condensation on the wall of the tubular member.

4. The device of claim 1, further comprising a collection substrate located downstream of the converging nozzle for collecting the grown droplets that contain aerosol particles discharged from the converging nozzle; and optionally the collection substrate is rotatable.

5. The device of claim 4, wherein the collection substrate is a collection electrode, and the device further comprises a counter spark electrode spaced apart from the collection electrode to define a spark gap.

6. The device of claim 4, further comprising an analytical component to facilitate the characterization of the aerosol particles collected on the collection substrate; and optionally the analytical component comprises a Raman probe, an infrared probe, or a combination thereof.

7. The device of claim 1, further comprising a cooling device operative to reduce a temperature of a wall of the growth tube to less than 15° C., preferably 0° C. to 13° C., 0° C. to 10° C., or about 0° C.

8. The device of claim 7, further comprising:
an impactor coupled to the converging nozzle; and
a container connected to the impactor via a connector for collecting the grown droplets that contain aerosol particles in liquid suspension;
wherein optionally the cooling device comprises a thermoelectric cooler disposed on an external surface of the growth tube; and a heatsink disposed between a fan and the thermoelectric cooler.

9. A device for collecting and analyzing aerosol particles, the device comprising:
a converging nozzle for discharging an aerosol stream containing aerosol particles;
a collection substrate located downstream of the converging nozzle for collecting aerosol particles from the aerosol stream;
a controller coupled to the collection substrate for controlling a rotation of the collection substrate; and
a means for ablating the aerosol particles on the collection substrate.

10. The device of claim 9, wherein the means for ablating the aerosol particles on the collection substrate comprises a means for generating a plasma discharge, the plasma discharge comprising at least one of a pulsed laser, a pulsed microplasma, a pulsed spark discharge, a laser, a radio frequency glow discharge, a laser-induced plasma, or a microwave-induced plasma; and
optionally the means for ablating the aerosol particles on the collection substrate comprises a counter spark electrode spaced apart from the collection substrate to define a spark gap; and a means for applying a voltage pulse between the collection substrate and a counter spark electrode to generate a pulsed spark discharge that ablates the aerosol particles on the collection substrate.

11. The device of claim 9, wherein the device further comprises a Raman probe, an infrared probe, or a combination thereof.

12. The device of claim 9 wherein the device further comprises:
a fluid storage tank for generating a condensing fluid comprising a vapor, the condensing fluid having a first temperature;
an aerosol collection port having a vapor inlet for receiving the condensing fluid generated from the fluid storage tank, and
an aerosol inlet for receiving an aerosol stream containing aerosol particles, the aerosol stream having a second temperature that is lower than the first temperature, wherein the condensing fluid is mixed with the aerosol stream in the aerosol collection port producing a mixed stream;
a growth tube configured to receive the mixed stream from the aerosol collection port and condense the aerosol particles to form a gaseous stream containing grown droplets that contain aerosol particles; and
the converging nozzle is in fluid communication with the growth tube, the converging nozzle focusing the condensed fluid into an aerosol beam containing the grown droplets that contain aerosol particles.

13. A method for collecting and analyzing aerosol particles with the device of claim 1, the method comprising:
generating the condensing fluid containing the vapor;
mixing the condensing fluid with the aerosol stream in the aerosol collection port to produce a mixed stream;
introducing the mixed stream to the growth tube;
condensing the aerosol particles to form the gaseous stream containing grown droplets that contain aerosol particles in the growth tube; and
focusing the gaseous stream containing the grown droplets into the aerosol beam.

14. The method of claim 13, wherein one or more of the following conditions apply:
the aerosol stream is introduced into the aerosol collection port at a flowrate of 1 to 20 liters per minute;
the vapor is generated at a temperature of 75° C. to 90° C. in the fluid storage tank;
the aerosol stream has a relative humidity of 9 to 100%;
the condensing fluid is adiabatically mixed with the aerosol stream in the aerosol collection port; or
a temperature of a wall of the growth tube is reduced to less than 15° C. or 0 to 13° C.

15. The method of claim 13, further comprising:
depositing the grown droplets that contain aerosol particles discharged from the converging nozzle on the collection substrate; and
analyzing the deposited aerosol particles.

16. A method for analyzing aerosol particles with the device of any one of claims 9 to 12, the method comprising
collecting aerosol particles on a collection substrate at an original orientation;
rotating the collection substrate to a new ablating orientation;
ablating the aerosol particles on the collection substrate in the new ablating orientation; and
rotating the collection substrate back to the original orientation for subsequent collection of next sample of aerosol particles.

17. The method of claim 16, further comprising
generating an atomic emission; and
analyzing the atomic emission to characterize the aerosol particles on the collection substrate.

18. The method of claim 16, wherein the aerosol particles on the collection substrate are ablated with a plasma discharge, and wherein the plasma discharge comprises at least one of a pulsed laser, a pulsed microplasma, a pulsed spark discharge, a radio frequency glow discharge, a laser, a laser-induced plasma, or a microwave-induced plasma.

19. The method of claim 16, wherein the aerosol particles on the collection substrate are ablated with a pulsed spark discharge, and the method further comprises applying a voltage pulse between the collection substrate and the counter spark electrode to generate a pulsed spark discharge to ablate the aerosol particles on the collection substrate.

20. The method of claim 16, wherein the method further comprises rotating the collection substrate to a measurement orientation before the aerosol particles on the collection substrate are ablated; and analyzing the aerosol particles on the collection substrate with an optical spectroscopy; and optionally the method comprises irradiating the collected aerosol particles on the collection substrate with a laser beam, allowing a Raman, reflectance, or absorption measurement.

21. A method for analyzing aerosol particles, the method comprising:
analyzing first aerosol particles on a first surface of a collection substrate;
ablating second aerosol particles on a second surface of the collection substrate to generate an atomic emission; and
analyzing the atomic emission to characterize the second aerosol particles on the second surface of the collection substrate,
wherein optionally the first aerosol particles and the second aerosol particles are collected from the same or different aerosol streams.

22. The method of claim 21, further comprising collecting third aerosol particles on a third surface of the collection substrate, and wherein at least two of the collecting, the analyzing, and the ablating are performed simultaneously.

23. The method of claim 13, wherein the collecting aerosol particles or collecting third aerosol particles comprise:
generating a condensing fluid containing a vapor;
mixing the condensing fluid with an aerosol stream in an aerosol collection port to produce a mixed stream;
introducing the mixed stream to a growth tube;
condensing the aerosol particles to form a gaseous stream containing grown droplets that contain aerosol particles in the growth tube;
focusing the gaseous stream containing the grown droplets into the aerosol beam; and
depositing the grown droplets that contain aerosol particles discharged from the converging nozzle on the collection substrate.
